(19) United States
(12) Patent Application Publication
(10) Pub. No.: US 2026/0313573 A1
(43) Pub. Date: Oct. 8, 2026

(54) MAXIMUM AUTONOMOUS TA ADJUSTMENTS FOR AREA-SPECIFIC UPLINK TRANSMISSIONS

(71) Applicant: QUALCOMM Incorporated, San Diego, CA (US)

(72) Inventors: Alexandros MANOLAKOS, Athens (GR); Sony AKKARAKARAN, Poway, CA (US); Jae Ho RYU, San Diego, CA (US); Carlos CABRERA MERCADER, Cardiff, CA (US)

(21) Appl. No.: 19/477,025

(22) PCT Filed: Mar. 7, 2024
(86) PCT No.: PCT/US2024/018951

§ 371 Date: Oct. 20, 2025

(30) Foreign Application Priority Data
May 18, 2023 (GR) 20230100407

(51) Int. Cl. H04W 56/00

(52) U.S. Cl. CPC H04W 56/0045; H04W 56/001

(57) ABSTRACT

Aspects presented herein may improve the accuracy and performance of UE positioning by providing a UE with more flexibility in determining or calculating timing advance (TA) and/or in performing transmission timing adjustment(s). In one aspect, a UE obtains an indication of a first TA adjustment procedure and a second TA adjustment procedure. The UE applies at least one of the first TA adjustment procedure or the second TA adjustment procedure if a set of transmissions is associated with multiple cells. The UE transmits the set of transmissions based on the application of the first TA adjustment procedure or the second TA adjustment procedure.

### CROSS REFERENCE TO RELATED APPLICATION(S)

This application claims the benefit of and priority to Greek Patent Application No. 20230100407, entitled “MAXIMUM AUTONOMOUS TA ADJUSTMENTS FOR AREA-SPECIFIC UPLINK TRANSMISSIONS” and filed on May 18, 2023, which is expressly incorporated by reference herein in its entirety.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus obtains an indication of a first timing advance (TA) adjustment procedure and a second TA adjustment procedure. The apparatus applies at least one of the first TA adjustment procedure or the second TA adjustment procedure if a set of transmissions is associated with multiple cells. The apparatus transmits the set of transmissions based on the application of the first TA adjustment procedure or the second TA adjustment procedure.

In an aspect of the disclosure, a method, a computer-readable medium, and an apparatus are provided. The apparatus configures at least one of a first timing advance (TA) adjustment procedure or a second TA adjustment procedure for a set of transmissions being associated with multiple cells. The apparatus transmits, for a user equipment (UE), an indication of the first TA adjustment procedure and the second TA adjustment procedure. The apparatus receives, from the UE, the set of transmissions based on an application of the first TA adjustment procedure or the second TA adjustment procedure.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of pre-configured sounding reference signal (SRS) configurations in accordance with various aspects of the present disclosure.

FIG. 6 is a diagram illustrating an example of information elements (IEs) associated with pre-configured SRS configurations in accordance with various aspects of the present disclosure.

FIG. 7 is a diagram illustrating an example of applying timing advance (TA) to UL transmissions of UEs in accordance with various aspects of the present disclosure.

FIG. 8 is a communication flow illustrating an example of a UE being configured to apply different gradual or one shot timing adjustment thresholds and parameters for different scenarios and/or conditions in accordance with various aspects of the present disclosure.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a flowchart of a method of wireless communication.

FIG. 13 is a flowchart of a method of wireless communication.

FIG. 14 is a diagram illustrating an example of a hardware implementation for an example network entity.

### DETAILED DESCRIPTION

Aspects presented herein may improve the accuracy and performance of user equipment (UE) positioning by providing a UE with more flexibility in determining or calculating timing advance (TA) and/or in performing transmission timing adjustment(s) (e.g., gradual timing adjustment, one shot timing adjustment, etc.). For example, aspects presented herein may enable a UE to be configured with different gradual/one shot timing adjustment thresholds and parameters (e.g., T_{q}, Tₚ) under different scenarios when the UE is performing a cell-reselection. Different scenarios may include transmitting sounding reference signal(s) (SRS(s)) for positioning, transmitting SRS(s) for multiple-input multiple-output (MIMO) communication, transmitting a set of UL transmissions via a physical uplink shared channel (PUSCH), transmitting a set of uplink transmissions via a physical uplink control channel (PUCCH), or a combination thereof. In another example, different gradual/one shot timing adjustment thresholds and parameters (e.g., T_{q}, Tₚ) may also be configured for the UE based on the radio resource control (RRC) state/mode of the UE. For example, the UE may be configured to apply a first set of timing adjustment thresholds and parameters (T_{q}, Tₚ) when the UE is in a radio resource control (RRC) inactive/idle state/mode, and the UE may be configured to apply a second set of timing adjustment thresholds and parameters (T_{q}, Tₚ) when the UE is in an RRC connected state/mode, etc.

In another aspect of the present disclosure, for the determination of uplink (UL) timing to transmit SRS for positioning by UEs in an RRC inactive state/mode within an SRS positioning validity area, a UE may be configured to determine a valid TA based on (1) maintaining the TA obtained from the last serving cell within the validity area (and the UE may still be able to perform autonomous adjustment(s) as described above), or (2) up to the UE capability, if the UE is configured by the network, the UE may autonomously adjust the TA such that the UL timing remains constant with respect to the UL timing before reselecting to the new camping cell, when the DL reference timing difference between the last camping cell and the new camping cell exceeds a threshold. The DL reference timing may be configured to follow the DL timing of current camping cell.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

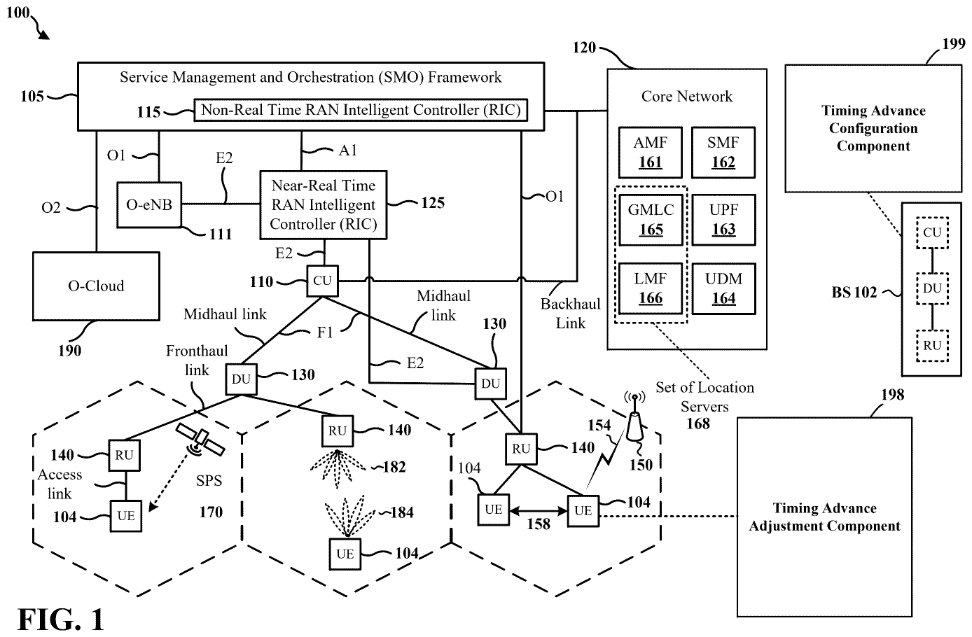

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to YMHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a timing advance adjustment component 198 that may be configured to obtain an indication of a first TA adjustment procedure and a second TA adjustment procedure; apply at least one of the first TA adjustment procedure or the second TA adjustment procedure if a set of transmissions is associated with multiple cells; and transmit the set of transmissions based on the application of the first TA adjustment procedure or the second TA adjustment procedure.

In certain aspects, the base station 102 may include a timing advance configuration component 199 that may be configured to configure at least one of a first TA adjustment procedure or a second TA adjustment procedure for a set of transmissions being associated with multiple cells; transmit, for a UE, an indication of the first TA adjustment procedure and the second TA adjustment procedure; and receive, from the UE, the set of transmissions based on an application of the first TA adjustment procedure or the second TA adjustment procedure.

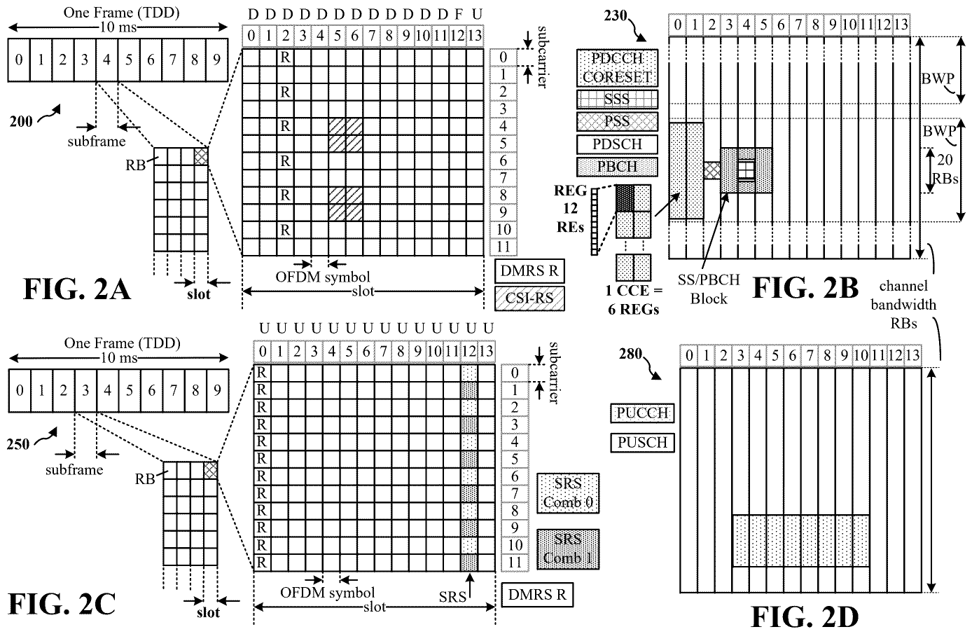

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

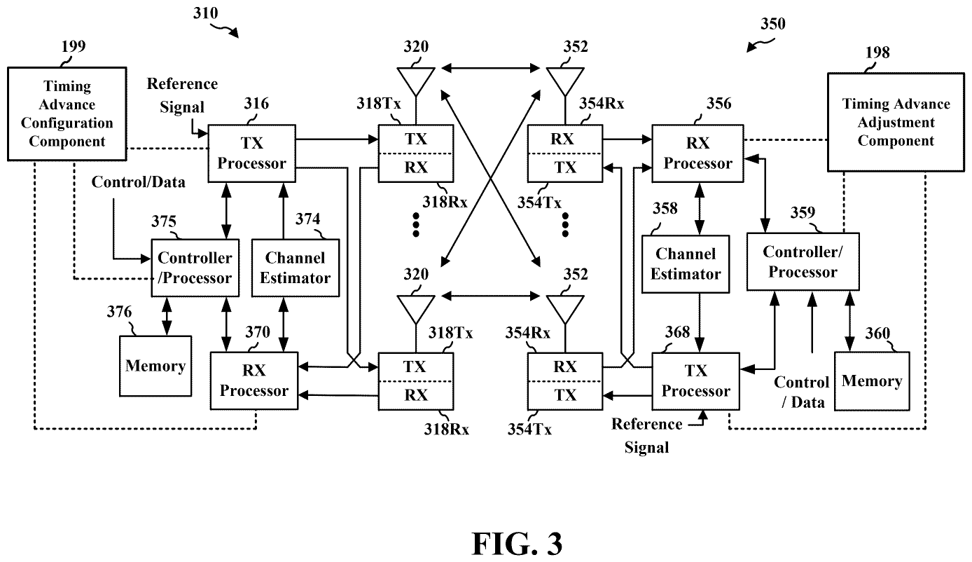

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the timing advance adjustment component 198 of FIG. 1.

At least one of the TX processor 316, the RX processor 370, and the controller/processor 375 may be configured to perform aspects in connection with the timing advance configuration component 199 of FIG. 1.

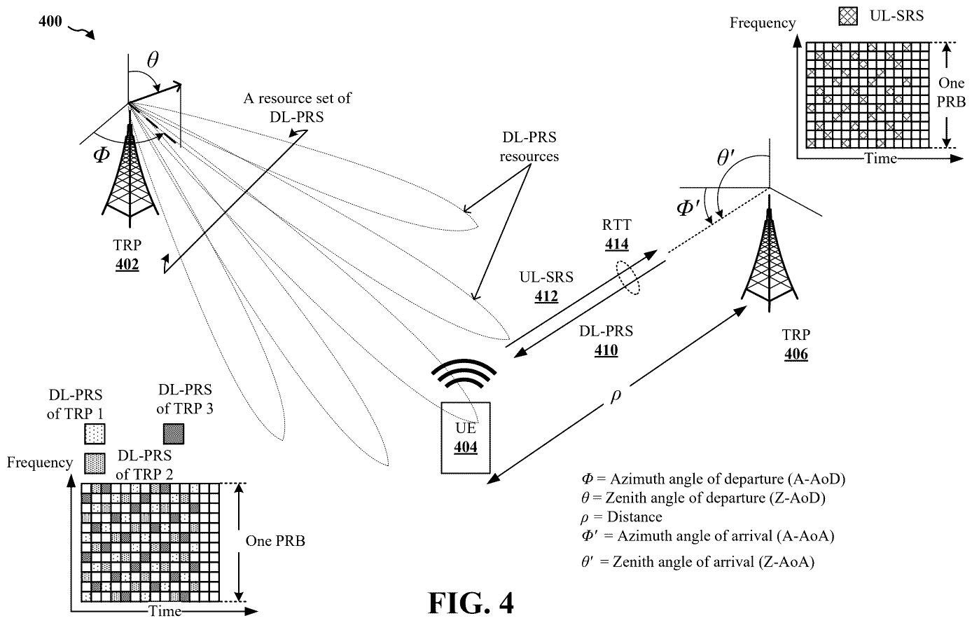

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In some implementations, a UE may be pre-configured with a set of sounding reference signal (SRS) configurations in which the UE may apply when the UE is under a radio resource control (RRC) inactive/idle state/mode. For example, like positioning reference signal (PRS) assistance data (AD), SRS configuration(s) may be provided to a UE (e.g., by a location server such as a location management function (LMF)), as part of an LTE positioning protocol (LPP) request or positioning system information block (SIB) broadcast. For purposes of the present disclosure, SRS pre-configuration(s) may refer to SRS configuration(s) pre-configured for a UE, which may include parameters and resources associated with transmitting SRSs (e.g., to one or more base stations/TRPs). For example, based on an SRS pre-configuration, a UE may be specified to transmit a set of SRSs to one or more base stations/TRPs using a specified time and frequency resources, bandwidth, and/or periodicity, etc. In some examples, the term “SRS pre-configuration(s)” may be used interchangeably with the term “SRS configuration(s)” for purposes of the present disclosure.

An RRC idle state/mode may refer to a state/mode of a UE in which the UE is switched on but does not have any established RRC connection (e.g., with the network). No RRC connection may mean that the presence of the UE is, in general, not known to the network at the cell level because a base station may not have any context for the UE. In some examples, the location of the UE in an RRC idle state/mode may be known to the network at the level of tracking areas, which consist of cells. An example/advantage of transitioning a UE into an RRC idle state/mode may include reducing UE power consumption by utilizing, for example, discontinuous reception. Thus, the number of processes that the UE is specified to perform in an RRC idle state/mode may be significantly smaller than in an RRC connected state/mode. The term “camp on” may be used when UE behaviors in an RRC idle state/mode are described. For example, “camp on” may refer to a UE state/mode in which the UE stays on a cell and is ready to initiate a potential dedicated service or to receive an ongoing broadcast service. An RRC inactive state/mode may be similar to or the same as an RRC idle state/mode, with the exception that the UE may store an RRC context for certain period of time in some examples. After some timer expiry, the UE may delete that context and move to an RRC idle state/mode. In some implementations, there may also be additional RRC mode(s)/state(s) between the RRC connected state/mode and the RRC idle state/mode, where the network and/or the UE may optionally stay in an RRC inactive state/mode without completely releasing the RRC when there is no traffic and quickly switch back to the RRC connected state/mode when specified. In this state/mode, the UE may be put in a dormant state/mode which does not do any data transmission, but NAS layer may remain connected and RRC may not be completely released. In some examples, this special state/mode may be referred to as RRC inactive state/mode.

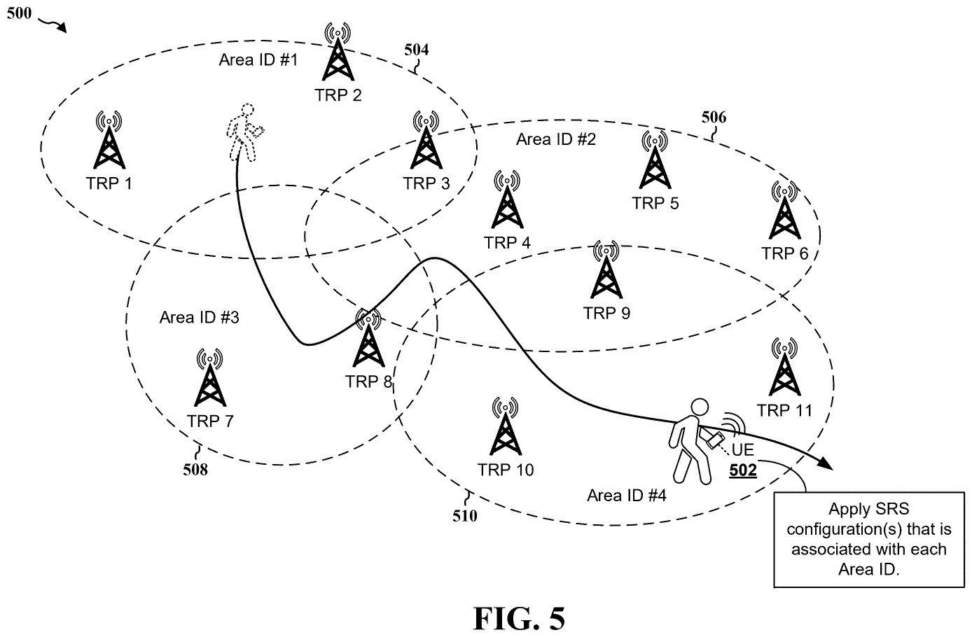

FIG. 5 is a diagram 500 illustrating an example of pre-configured SRS configurations in accordance with various aspects of the present disclosure. In one aspect, a pre-configured SRS may consist of multiple SRS configurations, where each SRS configuration may be applicable to a different area within the network. Under the concept of SRS validity area (which may also be referred to as “SRS positioning validity area”), a UE 502 may use/apply an SRS configuration within a validity area of an area identification (ID), where an area ID may consist of one and multiple cells.

For example, as shown at 504, a first set of transmission reception points (TRPs) (e.g., TRPs #1, 2, and 3) may be associated with a first area ID (Area ID #1); as shown at 506, a second set of TRPs (e.g., TRPs #3, 4, 5, 6, and 9) may be associated with a second area ID (Area ID #2); as shown at 508, a third set of TRPs (e.g., TRPs #7 and 8) may be associated with a third area ID (Area ID #3); and as shown at 510, a fourth set of TRPs (e.g., TRPs #9, 10, and 11) may be associated with a fourth area ID (Area ID #4), etc. In one example, if a UE 502 is pre-configured with a set of SRS configurations, the UE 502 may be specified to apply different SRS configurations based on the area ID associated with the current location of the UE 502. In addition, the UE 502 may be under an RRC inactive/idle state when applying the SRS configuration(s). For example, when the UE 502 is within the area associated with the first area ID, the UE 502 may apply an SRS configuration that corresponds to the first area ID, such as transmitting a set of SRSs to TRP(s) #1, 2, and/or 3 using specified time resources, frequency resources, periodicity, bandwidth, etc. Similarly, when the UE 502 is within the area associated with the fourth area ID, the UE 502 may apply another SRS configuration that corresponds to the fourth area ID, such as transmitting a set of SRSs to TRP(s) #9, 10, and/or 11 using specified time resources, frequency resources, periodicity, bandwidth, etc. As such, the SRS configuration associated with each area ID may be different. During this period, the UE 502 may be described as within an SRS (positioning) validity area.

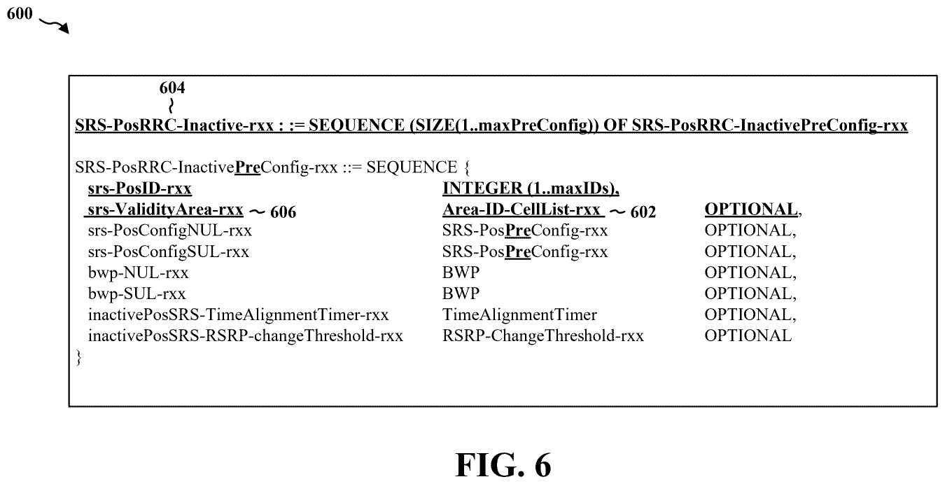

FIG. 6 is a diagram 600 illustrating an example of information elements (IEs) associated with pre-configured SRS configurations in accordance with various aspects of the present disclosure. In one example, to enable more network control over the positioning SRS transmission after cell reselection, as shown at 602, an LPP Area-ID-CellList parameter/IE may be added to a (pre-)configured positioning SRS. Compared to a DL-PRS assistance data validity, the Area-ID-CellList parameter for positioning SRS may be UE specific. If a UE (e.g., the UE 502) camps on a cell whose ID is included in the Area-ID-CellList parameter, then the UE may be permitted to continue the (associated) positioning SRS transmission in the new cell after cell reselection.

As shown at 604, an SRS-PosRRC-Inactive parameter may be used to provide a set of up to a maximum pre-configuration (maxPreConfig) positioning SRS configurations, where each configuration can be identified by an SRS positioning ID (srs-PosID). As shown at 606, the srs-ValidityArea parameter may be used for providing a list of Cell IDs where this SRS configuration is valid. If a UE reselects to a cell included in the Area-ID-CellList parameter, the UE is permitted to continue SRS transmission during and/or after the cell reselection. In some examples, the Area-ID-CellList parameter may not coincide with a radio access network (RAN)-based notification area (RNA) and may be a dedicated, UE-specific, UL positioning area. Such configuration, may avoid SRS interruption at cell reselection, which may reduce the amount of SRS configuration signalling specified and reduce the latency, and hence providing power consumption at a target device (e.g., a UE).

Timing advance (TA) is a technique that may be used (by a network or network entity/node) to control the transmission timing of a UE (or a set of UEs), such as controlling the uplink (UL) transmission timing of a UE to a network node (e.g., a base station, a transmission reception point (TRP), etc.), or controlling the sidelink (SL) transmission timing of a UE to another UE, etc. Thus, TA may be utilized by a network to ensure that UL transmissions from a plurality of UEs are synchronized when the UL transmissions are received by a network.

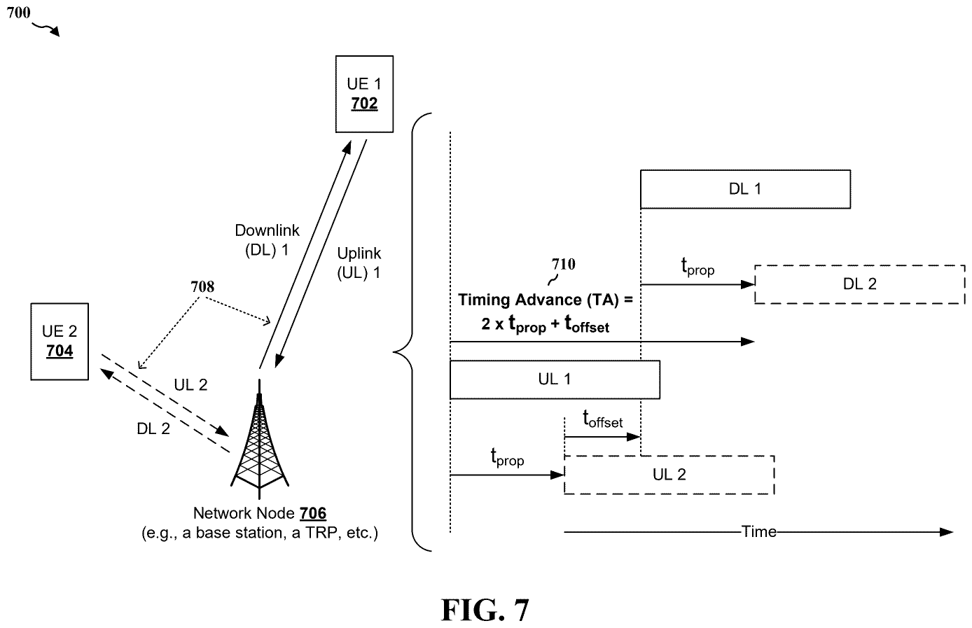

FIG. 7 is a diagram 700 illustrating an example of applying TA to UL transmissions of UEs in accordance with various aspects of the present disclosure. A network node 706 may be communicating with a first UE 702 and a second UE 704, such as transmitting downlink (DL) transmissions (DL 1 and DL 2) to the first UE 702 and the second UE 704, and/or receive UL transmissions (UL 1 and UL 2) from the first UE 702 and the second UE 704, respectively.

In one example, an uplink frame number i for an UL transmission from a UE (e.g., the first UE 702, the second UE 704, etc.) may be defined to start at T_{TA}=(N_{TA}+N_{TA,offset})·T_{c} before the start of the corresponding DL frame at the UE. For example, as shown at 708, a UE (e.g., the second UE 704) that is closer to a network node (e.g., the network node 706) may have a shorter propagation delay compared to a UE (e.g., the first UE 702) that is further away from the network node. Hence, the second UE 704 may have a smaller TA compared to the first UE 702.

As shown at 710, TA may be account for the round trip propagation delay (e.g., hence 2×tₚᵣₒₚ). In some examples, TA may also include a timing offset (t_{offset})=N_{TA,offset}·T_{c}, which may be used by a network node to activate its transmitter after an uplink frame. In one example, from a UE's perspective, a reference point for the UE's initial transmit timing control specification may be the DL timing of the reference cell minus (N_{TA}+N_{TA,offset}·T_{c}), which is TA. The DL timing may be defined as the time when a first detected path (in time) of the corresponding DL frame is received from the reference cell. From a network node's perspective, a time difference between an UL radio frame and the corresponding DL radio frame may be the t_{offset}, which may be the same for UEs attached to it. The propagation delay may already be compensated at a UE side by TA. Note that NTA for a physical random access channel (PRACH) may equal to zero (0), and Tc=1/(480 kHz·4096)=0.509 ns. In some examples, a UE may be provided with a value N_{TA,offset} of a TA offset for a serving cell by a parameter n-TimingAdvanceOffset in ServingCellConfigCommon or ServingCellConfigCommonSIB for the serving cell.

In some network implementations, it may be suitable/feasible to configure a UE in an SRS positioning validity area with a TA timer that is specific to the SRS positioning validity area (which may be referred to as an “SRS positioning validity area-specific TA timer”), where the values for the TA timer may be larger for a UE in an RRC inactive/idle state/mode compared to the UE in an RRC connected state/mode. Also, for TA validation, use of area-specific reference signal received power (RSRP) change threshold is feasible, where different types of reference signal (RS) may be used as the reference RS for the RSRP change threshold.

In one example, there may be a variety of options for determining the UL timing to transmit a set of SRSs for positioning by UEs in an RRC inactive/idle state/mode within an SRS positioning validity area. These options may also include a DL reference timing as the UL timing may be calculated based on the DL timing and the TA as described in connection with FIG. 7, e.g., UL Timing=DL Timing+TA. In one option, a UE may be configured to maintain the TA obtained from a last serving cell within the SRS positioning validity area. In another option, the UE may be configured to autonomously adjust the TA. How the UE adjusts the TA may be up to the UE implementation(s), or based on the TA from the last serving cell and the DL time difference measurement of synchronization signal blocks (SSBs) from a last serving cell and a new camping cell of the UE. In another option, the UE may be configured to maintain multiple TA values, e.g., the UE may obtain the TA using random-access channel (RACH).

In some scenarios, a UE may be configured to apply a gradual timing adjustment for its transmission(s) under certain conditions. For example, when the transmission timing error between the UE and a reference timing exceeds ±T_{c} (e.g., a timing error threshold/range), the UE may be specified to adjust its timing to within ±T_{c}. In one example, the reference timing may be calculated based on (N_{TA}+N_{TA,offset})×T_{c} before the DL timing of the reference cell. All adjustments made to the UE UL timing may be configured to follow the following rules:
1) The maximum amount of the magnitude of the timing change in one adjustment is T_{q},
2) The minimum aggregate adjustment rate is Tₚ per second, and
3) The maximum aggregate adjustment rate is T_{q} per 200 ms.

In one example, the values for the maximum autonomous time adjustment step T_{q} and the aggregate adjustment rate Tₚ may be pre-defined/specified. For example, Table 2 below shows example pre-defined values for the maximum autonomous time adjustment step (T_{q}) and the minimum aggregate adjustment rate (Tₚ). In addition, the UE may be configured to apply these rules regardless of whether the reference cell is on a carrier frequency subject to clear channel assessment (CCA) or not.

TABLE 2
T_{q} maximum autonomous time adjustment step
and Tₚ Minimum aggregate adjustment rate

| Frequency | SCS of uplink | | |
|---|---|---|---|
| Range | signals (kHz) | T_{q} | Tₚ |
| 1 | 15 | 5.5*64*T_{c} | 5.5*64*T_{c} |
| | 30 | 5.5*64*T_{c} | 5.5*64*T_{c} |
| | 60 | 5.5*64*T_{c} | 5.5*64*T_{c} |
| 2 | 60 | 2.5*64*T_{c} | 2.5*64*T_{c} |
| | 120 | 2.5*64*T_{c} | 2.5*64*T_{c} |

NOTE:
T_{c} is the basic timing unit (e.g., Tc = 1/(480 kHz · 4096) = 0.509 ns

In some scenarios, a UE may be configured to apply a one shot adjustment (which may also be referred to as “one shot timing adjustment”) for its transmission(s) under certain conditions. For example, when the magnitude of the ΔT (e.g., a time difference) exceeds H (e.g., a time difference threshold), the UE may be specified to adjust its transmission timing in one adjustment just once provided that the following conditions are met at the UE. Otherwise when the magnitude of the ΔT is smaller than or equal to H (e.g., ΔT≤H), the UE may adjust its transmission timing based on the gradual timing adjustment described above. ΔT may correspond to a time difference between the reception time at the UE just before the one shot timing adjustment and the reception time to be used at the UE just after the one shot timing adjustment. For example, ΔT=|T₁−T₂|, where T₁ is the reception time at the UE just before the one shot timing adjustment, and T₂ is the reception time to be used at the UE just after the one shot timing adjustment. The value for H may be pre-defined (e.g., using a table similar to Table 2 above). Also, the UE transmit timing immediately after applying the one shot timing adjustment may be computed based on: T₂−(N_{TA}+N_{TA offset})+2×(T₁−T₂). In some implementations, after applying the one shot timing adjustment, the UE may adjust its transmission timing based on the gradual timing adjustment described above.

Aspects presented herein may improve the accuracy and performance of UE positioning by providing a UE with more flexibility in determining or calculating TA and/or in performing transmission timing adjustment(s) (e.g., gradual timing adjustment, one shot timing adjustment, etc.). For example, aspects presented herein may enable a UE to be configured with different gradual/one shot timing adjustment thresholds and parameters (e.g., T_{q}, Tₚ) under different scenarios when the UE is performing a cell-reselection. Different scenarios may include transmitting SRS(s) for positioning, transmitting SRS(s) for multiple-input multiple-output (MIMO) communication, transmitting a set of UL transmissions via a physical uplink shared channel (PUSCH), transmitting a set of uplink transmissions via a physical uplink control channel (PUCCH), or a combination thereof. In another example, different gradual/one shot timing adjustment thresholds and parameters (e.g., T_{q}, Tₚ) may also be configured for the UE based on the radio resource control (RRC) state/mode of the UE. For example, the UE may be configured to apply a first set of timing adjustment thresholds and parameters (T_{q}, Tₚ) for gradual/one shot timing adjustment(s) when the UE is in an RRC inactive/idle state/mode, and the UE may be configured to apply a second set of timing adjustment thresholds and parameters (T_{q}, Tₚ) for gradual/one shot timing adjustment(s) when the UE is in an RRC connected state/mode, etc.

In another aspect, for a UE in an RRC inactive state/mode and is within an SRS positioning validity area, to determine an UL timing to transmit SRS for positioning by UEs, the UE may be configured to support the determination of a valid TA based on (1) maintaining the TA obtained from the last serving cell within the validity area (and the UE may still be able to perform autonomous adjustment(s) as described above), or (2) up to the UE capability, if the UE is configured by the network, the UE may autonomously adjust the TA such that the UL timing remains constant with respect to the UL timing before reselecting to the new camping cell, when the DL reference timing difference between the last camping cell and the new camping cell exceeds a threshold. The DL reference timing may be configured to follow the DL timing of current camping cell.

In one aspect of the present disclosure, a UE may be configured with different gradual/one shot timing adjustment thresholds and parameters (e.g., T_{q}, Tₚ) based on the mobility of the UE. For example, when a UE is moving between different cells and is connecting/switching to different cells (which may be referred to as inter-cell mobility), the UE may be configured with a set of timing adjustment thresholds and parameters (e.g., T_{q}, Tₚ) that is more loose (e.g., with higher or more flexible range or limits) compared to a UE that is moving within a cell (which may be referred to as intra-cell mobility). As described in connection with FIG. 7, a UE that is travelling between cells is more likely to move faster or further away from a cell compared to a UE that is moving within a cell. Therefore, the UE may specify a larger TA or higher transmission timing adjustment. In some examples, by enabling a UE that is moving between multiple cells (e.g., under inter-cell mobility) to adjust its transmission timing with higher ranges/limits, the UE may be more likely to maintain its transmission timing error under a specified timing error threshold. For purposes of the present disclosure, timing adjustment thresholds and parameters associated with inter-cell mobility may collectively be referred to as “inter-cell mobility gradual adjustment(s),” whereas timing adjustment thresholds and parameters associated with intra-cell mobility may collectively be referred to as “intra-cell mobility gradual adjustment(s),” In some examples, transmission(s) occurring within a cell may be referred to as “intra-cell transmission(s),” whereas transmission(s) that are associated with multiple/different cells may be referred to as “inter-cell transmission(s).”

For example, in one aspect, for the case where a UE is capable of performing an autonomous adjustment (for its TA or transisthmian) when the UE determines there is a large difference in the DL reference time change before and after cell-reselection (e.g., the difference exceeds a threshold), the UE may still be configured or expected to perform just gradual timing adjustment(s). However, the limits/ranges for the gradual timing adjustment(s) may be more loose compared to the gradual timing adjustments applied on other scenarios, such as when the UE is moving within a cell, the UE is in an RRC connected state/mode, etc. For example, compare to other scenarios, the value(s) of the maximum amount of the magnitude of the timing change in one adjustment (e.g., T_{q}) may be different or higher (e.g., different or higher values compared to the values in Table 2), the value for the minimum aggregate adjustment rate may also be different or higher (e.g., a different Tₚ value, or same Tₚ value but per different time units, e.g., Tₚ per minute, Tₚ per 10 seconds, etc.), and/or the maximum aggregate adjustment rate may also be different or higher (e.g., a different T_{q} value, or same T_{q} value but per different time units, e.g., T_{q} per 400 ms, T_{q} per 800 ms, etc.).

Table 3 below shows example values for maximum autonomous time adjustment step (T_{q}) and the minimum aggregate adjustment rate (Tₚ) associated with inter-cell mobility gradual adjustment(s) in accordance with various aspects of the present disclosure.

TABLE 3
T_{q} maximum autonomous time adjustment step and
Tₚ minimum aggregate adjustment rate associated
with inter-cell mobility gradual adjustment(s)

| Frequency | SCS of uplink | | |
|---|---|---|---|
| Range | signals (kHz) | T_{q} | Tₚ |
| 1 | 15 | K*5.5*64*T_{c} | K*5.5*64*T_{c} |
| | 30 | K*5.5*64*T_{c} | K*5.5*64*T_{c} |
| | 60 | K*5.5*64*T_{c} | K*5.5*64*T_{c} |
| 2 | 60 | K*2.5*64*T_{c} | K*2.5*64*T_{c} |
| | 120 | K*2.5*64*T_{c} | K*2.5*64*T_{c} |

NOTE:
T_{c} is the basic timing unit (e.g., Tc = 1/(480 kHz · 4096) = 0.509 ns)

The (new) T_{q} and Tₚ values in Table 3 may be multiples of the previous values (e.g., shown by Table 2) by a factor of “K”, where K=2, 4, 8, 16, 32, etc. As such, the maximum amount of magnitude in one adjustment and the maximum aggregated adjustment may have looser or more flexible values in the inter-cell mobility case compare to the conventional (e.g., legacy) and/or cell-specific gradual adjustment(s).

In another aspect, for the case where a UE is expected to maintain the TA from the last serving cell within a validity area, the UE may still be configured or expected to perform gradual timing adjustment(s). However, the limits/ranges for the gradual timing adjustment(s) may be more loose compared to the gradual timing adjustments applied on other scenarios, such as when the UE is moving within a cell (e.g., under intra-cell mobility), the UE is in an RRC connected state/mode, etc. For example, compare to other scenarios, the value(s) of the maximum amount of the magnitude of the timing change in one adjustment (e.g., T_{q}) may be different or higher (e.g., different or higher values compared to the values in Table 2), the value for the minimum aggregate adjustment rate may also be different or higher (e.g., a different Tₚ value, or same Tₚ value but per different time units, e.g., Tₚ per minute, Tₚ per 10 seconds, etc.), and/or the maximum aggregate adjustment rate may also be different or higher (e.g., a different T_{q} value, or same T_{q} value but per different time units, e.g., T_{q} per 400 ms, T_{q} per 800 ms, etc.).

Table 4 below shows example values for maximum autonomous time adjustment step (T_{q}) and the minimum aggregate adjustment rate (Tₚ) associated with inter-cell mobility gradual adjustment(s) for UEs that are expected to maintain the TA from the last serving cell within the validity area in accordance with various aspects of the present disclosure.

TABLE 4
T_{q} maximum autonomous time adjustment step and
Tₚ minimum aggregate adjustment rate associated
with inter-cell mobility gradual adjustment(s)
for UEs that are expected to maintain the TA from
the last serving cell within the validity area

| Frequency | SCS of uplink | | |
|---|---|---|---|
| Range | signals (kHz) | T_{q} | Tₚ |
| 1 | 15 | K*5.5*64*T_{c} | K*5.5*64*T_{c} |
| | 30 | K*5.5*64*T_{c} | K*5.5*64*T_{c} |
| | 60 | K*5.5*64*T_{c} | K*5.5*64*T_{c} |
| 2 | 60 | K*2.5*64*T_{c} | K*2.5*64*T_{c} |
| | 120 | K*2.5*64*T_{c} | K*2.5*64*T_{c} |

NOTE:
T_{c} is the basic timing unit (e.g., Tc = 1/(480 kHz · 4096) = 0.509 ns)

The (new) T_{q} and Tₚ values in Table 4 may be multiples of the previous values (e.g., shown by Table 2) by a factor of “K”, where K=2, 4, 8, 16, 32, etc. As such, the maximum amount of magnitude in one adjustment and the maximum aggregated adjustment may have looser or more flexible values in the inter-cell mobility case compare to the conventional (e.g., legacy) and/or cell-specific gradual adjustment(s).

In another example, for the case where a UE is capable of performing an autonomous adjustment (for its TA or transisthmian) when the UE determines there is a large difference in the DL reference time change between different SSB beams of the same serving cell (e.g., associated with the intra-cell mobility), the UE may still be configured or expected to perform just gradual timing adjustment(s). However, the limits/ranges for the gradual timing adjustment(s) may be stricter (e.g., with lower or less flexible range limits) compared to the gradual timing adjustments applied on other scenarios, such as when the UE is moving between cells (e.g., under inter-cell mobility). In other words, intra-cell mobility gradual adjustments may be configured with stricter upper bounds when the UE changes SSBs (e.g., reference signals) or SSB beams within a single cell.

For example, compare to other scenarios, the value(s) of the maximum amount of the magnitude of the timing change in one adjustment (e.g., T_{q}) may be different or lower (e.g., different or lower values compared to the values in Tables 2, 3, and/or 4), the value for the minimum aggregate adjustment rate may also be different or lower (e.g., a different Tₚ value, or same Tₚ value but per different time units), and/or the maximum aggregate adjustment rate may also be different or lower (e.g., a different T_{q} value, or same T_{q} value but per different time units), etc.

Table 5 below shows example values for maximum autonomous time adjustment step (T_{q}) and the minimum aggregate adjustment rate (Tₚ) associated with intra-cell mobility gradual adjustment(s) in accordance with various aspects of the present disclosure.

TABLE 5
T_{q} maximum autonomous time adjustment step and
Tₚ minimum aggregate adjustment rate associated
with intra-cell mobility gradual adjustment(s)

| Frequency | SCS of uplink | | |
|---|---|---|---|
| Range | signals (kHz) | T_{q} | Tₚ |
| 1 | 15 | K*5.5*64*T_{c} | K*5.5*64*T_{c} |
| | 30 | K*5.5*64*T_{c} | K*5.5*64*T_{c} |
| | 60 | K*5.5*64*T_{c} | K*5.5*64*T_{c} |
| 2 | 60 | K*2.5*64*T_{c} | K*2.5*64*T_{c} |
| | 120 | K*2.5*64*T_{c} | K*2.5*64*T_{c} |

NOTE:
T_{c} is the basic timing unit (e.g., Tc = 1/(480 kHz · 4096) = 0.509 ns)

The (new) T_{q} and Tₚ values in Table 5 may be multiples of the previous values (e.g., shown by Table 2) by a factor of “K”, where K may be smaller than 1 (e.g., K=0.5, 0.1, 0.01, etc.). As such, the maximum amount of magnitude in one adjustment and the maximum aggregated adjustment may have stricter or less flexible values in the intra-cell mobility case compare to the conventional (e.g., legacy) gradual adjustment(s).

In another example, for the case where a UE is capable of performing an autonomous adjustment (for its TA or transisthmian) when the UE determines there is a large difference in the DL reference time change (e.g., the difference is above a defined threshold) before and after cell-reselection, the maximum magnitude change in one adjustment (T_{q}) in which the UE may apply may be a fraction of ΔT, where ΔT may correspond to a time difference between the reception time at the UE just before the one shot timing adjustment and the reception time to be used at the UE just after the one shot timing adjustment. For example, ΔT=|T₁−T₂|, where T₁ is the reception time at the UE of the previous DL reference timing, and T₂ is the reception time at the UE of the newly selected DL reference timing. Fraction of ΔT may be K×ΔT, where K may be a value smaller than or equal to 1 (e.g., K=0.2, 0.5, 0.01, 1, etc.). As such, the maximum amount of the magnitude of the timing change in one adjustment (e.g., T_{q}) may be a different value compared to conventional (e.g., legacy) gradual adjustment(s). In one example, a UE may be configured/triggered to apply this option/configuration when the gradual adjustment TA with T_{q} is smaller than or equal to ΔT (e.g., gradual adjustment TA with Tq≤ΔT).

In another aspect of the present disclosure, for the case where a UE is capable of performing an autonomous adjustment (for its TA or transisthmian) when the UE determines there is a large difference in the DL reference time change, there UE may be configured to apply or meet the maximum amount of the magnitude of the timing change in one adjustment. However, the UE may not be specified to meet the minimum aggregate adjustment and/or the maximum aggregate adjustment, such that the UE may have more flexibility for adjustment of its TA and/or transmission.

In another aspect of the present disclosure, a UE may be configured with or apply different gradual or one shot timing adjustment thresholds and parameters (e.g., T_{q}, Tₚ) for different scenarios and under certain conditions. For example, a UE may be configured with or apply different gradual or one shot timing adjustment thresholds and parameters (compare to the conventional gradual adjustment(s)) when the UE is transmitting a set of SRSs for positioning, when the UE is transmitting a set of SRSs for MIMO communication, when the UE is transmitting a PUSCH transmission, and/or when the UE is transmitting a PUCCH transmission, etc.

In another example, a UE may be configured with or apply different gradual or one shot timing adjustment thresholds and parameters (e.g., T_{q}, Tₚ) based on the UE's RRC state/mode. For example, the UE may be configured to apply a first set of gradual or one shot timing adjustment thresholds and parameters when the UE is in an RRC inactive/idle state/mode, and the UE may be configured to apply a second set of gradual or one shot timing adjustment thresholds and parameters when the UE is in an RRC connected state/mode, the second set of gradual or one shot timing adjustment thresholds being at least partially different from the first set of gradual or one shot timing adjustment thresholds. In one example, this may enable a UE to apply one shot adjustment in an RRC inactive, but not in RRC connected state/mode.

In another aspect of the present disclosure, aspects described above (e.g., enabling a UE to be configured with or apply different gradual or one shot timing adjustment thresholds and parameters (e.g., T_{q}, Tₚ) for different scenarios and/or conditions) may also apply to TA adjustment for sidelink (SL) transmission, such as transmission of SL positioning reference signal (SL-PRS). For example, for the determination of SL-PRS transmission timing by UEs within an SL-PRS positioning validity area, a UE may be configured to support the determination of a valid TA based on (1) maintaining the TA obtained from the last synchronization source within the validity area (and the UE may still be able to perform autonomous adjustment(s) as described above), or (2) up to the UE capability, if the UE is configured by another UE, the UE may autonomously adjust the TA such that the SL timing remains constant with respect to the SL timing before reselecting to the new synchronization source, when the DL reference timing difference between the last synchronization source and the new synchronization source exceeds a threshold.

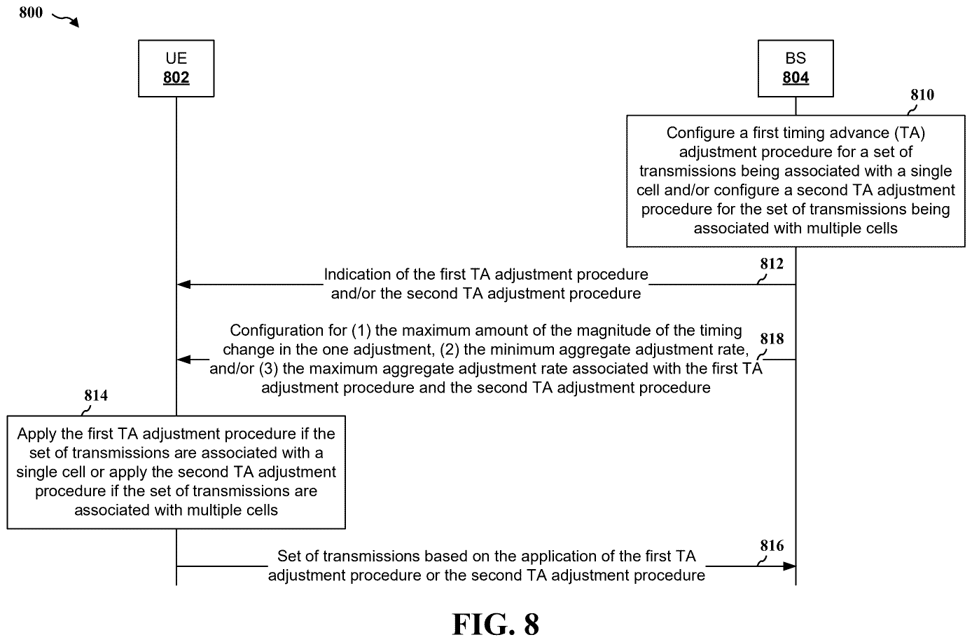

FIG. 8 is a communication flow 800 illustrating an example of a UE being configured to apply different gradual or one shot timing adjustment thresholds and parameters (e.g., T_{q}, Tₚ) for different scenarios and/or conditions in accordance with various aspects of the present disclosure. The numberings associated with the communication flow 800 do not specify a particular temporal order and are merely used as references for the communication flow 800.

At 810, a base station 804 (which may be referred to as a network node or a network entity), may configure a first TA adjustment procedure (e.g., a first set of gradual or one shot timing adjustment thresholds and parameters (T_{q} and Tₚ)) for a set of transmissions associated with a single cell (e.g., for applying on intra-cell mobility) and/or configure a second TA adjustment procedure (e.g., a second set of gradual or one shot timing adjustment thresholds and parameters (T_{q} and Tₚ) that is at least partially different from the first set of gradual or one shot timing adjustment thresholds and parameters) for the set of transmissions associated with multiple cells (e.g., for applying on inter-cell mobility).

At 812, the base station 804 may transmit, to or for a UE 802, an indication of the first TA adjustment procedure and the second TA adjustment procedure. In other words, the UE 802 may obtain an indication of the first TA adjustment procedure and the second TA adjustment procedure from the base station 804. For purposes of the present disclosure, when a first entity transmits a transmission (e.g., an indication, a configuration, a request, a data, etc.) “for” a second entity, it may indicate that the first entity is transmitting the transmission directly to the second entity, and/or that that the first entity is transmitting the transmission to the second entity via at least one other entity (e.g., a third entity). For example, when the base station 804 transmits the indication for the UE 802, it may refer that the base station 804 is transmitting the indication directly to the UE 802, or indirectly to the UE 802 via another network node, such as another base station or TRP, etc.

In one example, the indication may be explicit or implicit. For example, the base station 804 may explicitly indicate the UE 802 to apply at least one of the first TA adjustment procedure or the second TA adjustment procedure via signaling (e.g., via a message), and/or the base station 804 may implicitly indicate the UE 802 to apply at least one of the first TA adjustment procedure or the second TA adjustment procedure based on at least one property associated with the set of transmissions. For example, the UE 802 may be configured to apply at least one of the first TA adjustment procedure or the second TA adjustment procedure if the transmission is associated with positioning, is configured with specified resources, or is transmitted to a specific target, etc.

At 814, based on the indication of the first TA adjustment procedure and the second TA adjustment procedure, the UE 802 may apply at least one of the first TA adjustment procedure or the second TA adjustment procedure if a set of transmissions is associated with multiple cells. For example, the UE 802 may apply the first TA adjustment procedure if a set of transmissions from the UE 802 is associated with a single cell, or the UE 802 may apply the second TA adjustment procedure if the set of transmissions from the UE 802 is associated with multiple cells.

At 816, the UE 802 may transmit the set of transmissions based on the application of the first TA adjustment procedure or the second TA adjustment procedure. In some examples, the UE 802 may transmit the set of transmissions to the base station 804. In other examples, the UE 802 may transmit the set of transmissions to another UE if the set of transmissions is associated with sidelink transmissions. In other words, the base station 804 or another UE may receive, from the UE 802, the set of transmissions based on an application of the first TA adjustment procedure or the second TA adjustment procedure.

In one example, the first TA adjustment procedure may be associated with one reference signal (RS) for a downlink (DL) reference timing determination for the single cell, or the first TA adjustment procedure may be associated with a change to a synchronization signal block (SSB) for the one RS for the DL reference timing determination for the single cell. For purposes of the present disclosure, a DL reference timing (or a DL timing reference) may refer to a time when (e.g., the first detected path in time) a corresponding downlink frame is received by a UE from a reference cell or a reference transmission point.

In another example, each of the first TA adjustment procedure and the second TA adjustment procedure may be associated with at least one of: a maximum amount of magnitude of a timing change in one adjustment, a minimum aggregate adjustment rate, or a maximum aggregate adjustment rate. For purposes of the present disclosure, an aggregate adjustment rate may refer to the total/sum of a plurality of adjustment rates. In some examples, as shown by Tables 2 to 5, the maximum amount of the magnitude of the timing change in the one adjustment, the minimum aggregate adjustment rate, and/or the maximum aggregate adjustment rate may be determined further based on a frequency range and a subcarrier spacing. In some examples, as shown at 818, the base station 804 may also transmit, to the UE 802, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure.

In another example, the first TA adjustment procedure and the second TA adjustment procedure are different in at least one of: a maximum amount of magnitude of a timing change in one adjustment, a minimum aggregate adjustment rate, or a maximum aggregate adjustment rate. In some examples, at least one of the maximum amount of the magnitude of the timing change in the one adjustment, the minimum aggregate adjustment rate, or the maximum aggregate adjustment rate may be higher for the second TA adjustment compared to the first TA adjustment procedure.

In another example, the first TA adjustment procedure may be associated with intra-cell transmissions, and the second TA adjustment procedure is associated with an area ID or inter-cell transmissions.

In another example, the set of transmissions is at least one of: a set of reference signals (RSs) for positioning, a set of SL-PRSs, a first set of SRSs for positioning, a second set of SRSs for multiple-input multiple-output (MIMO) communication, a first set of uplink transmissions via a physical uplink shared channel (PUSCH), or a second set of uplink transmissions via a physical uplink control channel (PUCCH), etc.

In another example, the second TA adjustment procedure may be applied if the UE 802 moves from a first cell in the multiple cells to a second cell in the multiple cells.

In another example, the UE 802 may be is in an RRC inactive state or an RRC idle state within a positioning validity area. In some examples, the UE 802 may apply a third TA adjustment procedure for the set of transmissions if the UE is in an RRC connected state, where the third TA adjustment procedure may include a third set of gradual or one shot timing adjustment thresholds that is at least partially different from the first/second set of gradual or one shot timing adjustment thresholds.

In another example, each of the first TA adjustment procedure and the second TA adjustment procedure may include a maximum amount of magnitude of a timing change in one adjustment, the maximum amount being a fraction of a time difference between a reception time at the UE of a previous DL reference timing and a reception time at the UE of a newly selected DL reference timing.

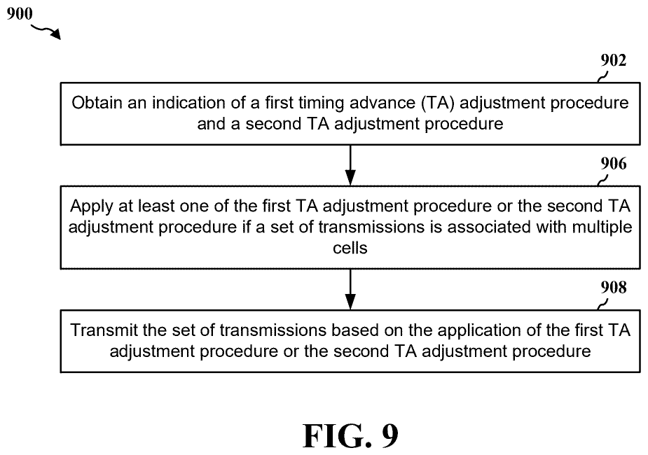

FIG. 9 is a flowchart 900 of a method of wireless communication. The method may be performed by a UE (e.g., the UE 104, 404, 502, 702, 704, 802; the apparatus 1104). The method may enable the UE to apply and/or to be configured with different gradual/one shot timing adjustment thresholds and parameters for different scenarios and/or conditions, such as when the UE is under inter-cell mobility or intra-cell mobility.

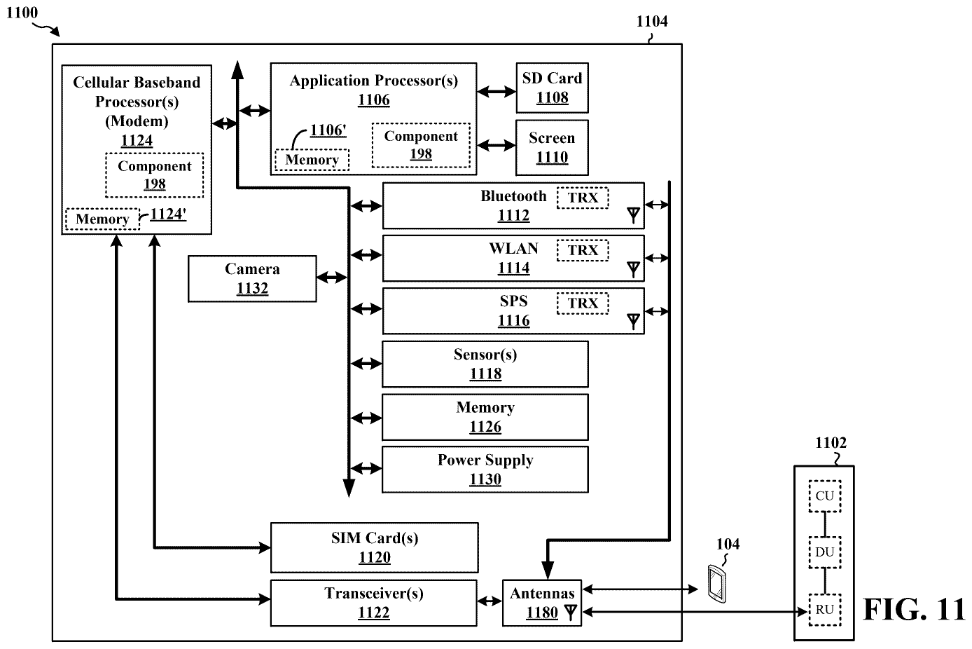

At 902, the UE may obtain an indication of a first TA adjustment procedure and a second TA adjustment procedure, such as described in connection with FIG. 8. For example, at 812, the UE 802 may obtain an indication of the first TA adjustment procedure and the second TA adjustment procedure from the base station 804. The obtaining of the indication may be performed by, e.g., the timing advance adjustment component 198, the transceiver(s) 1122, the cellular baseband processor(s) 1124, and/or the application processor(s) 1106 of the apparatus 1104 in FIG. 11.

In one example, the UE may receive, from a network node, a configuration for at least one of. (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure, such as described in connection with FIG. 8. For example, at 818, the UE 802 may receive, from the base station 804, a configuration for at least one of. (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure. The reception of the configuration may be performed by, e.g., the timing advance adjustment component 198, the transceiver(s) 1122, the cellular baseband processor(s) 1124, and/or the application processor(s) 1106 of the apparatus 1104 in FIG. 11.

At 906, the UE may apply at least one of the first TA adjustment procedure or the second TA adjustment procedure if a set of transmissions is associated with multiple cells, such as described in connection with FIG. 8. For example, at 814, based on the indication of the first TA adjustment procedure and the second TA adjustment procedure, the UE 802 may apply at least one of the first TA adjustment procedure or the second TA adjustment procedure if a set of transmissions is associated with multiple cells. The application of the first TA adjustment procedure and/or the second TA adjustment procedure may be performed by, e.g., the timing advance adjustment component 198, the transceiver(s) 1122, the cellular baseband processor(s) 1124, and/or the application processor(s) 1106 of the apparatus 1104 in FIG. 11. In some examples, to apply at least one of the first TA adjustment procedure or the second TA adjustment procedure if the set of transmissions is associated with multiple cells, the UE may apply the first TA adjustment procedure if the set of transmissions is associated with a single cell or apply the second TA adjustment procedure if the set of transmissions is associated with multiple cells.

At 908, the UE may transmit the set of transmissions based on the application of the first TA adjustment procedure or the second TA adjustment procedure, such as described in connection with FIG. 8. For example, at 816, the UE 802 may transmit the set of transmissions based on the application of the first TA adjustment procedure or the second TA adjustment procedure. The transmission of the set of transmissions may be performed by, e.g., the timing advance adjustment component 198, the transceiver(s) 1122, the cellular baseband processor(s) 1124, and/or the application processor(s) 1106 of the apparatus 1104 in FIG. 11.

In one example, the first TA adjustment procedure may be associated with one RS for a DL reference timing determination for the single cell, or the first TA adjustment procedure may be associated with a change to an SSB for the one RS for the DL reference timing determination for the single cell.

In another example, each of the first TA adjustment procedure and the second TA adjustment procedure may be associated with at least one of: a maximum amount of magnitude of a timing change in one adjustment, a minimum aggregate adjustment rate, or a maximum aggregate adjustment rate. In some implementations, the maximum amount of the magnitude of the timing change in the one adjustment, the minimum aggregate adjustment rate, and/or the maximum aggregate adjustment rate may be determined further based on a frequency range and a subcarrier spacing.

In another example, the first TA adjustment procedure and the second TA adjustment procedure may be different in at least one of a maximum amount of magnitude of a timing change in one adjustment, a minimum aggregate adjustment rate, or a maximum aggregate adjustment rate. In some implementations, at least one of the maximum amount of the magnitude of the timing change in the one adjustment, the minimum aggregate adjustment rate, or the maximum aggregate adjustment rate may be higher for the second TA adjustment compared to the first TA adjustment procedure.

In another example, the first TA adjustment procedure may be associated with intra-cell transmissions, and the second TA adjustment procedure is associated with an area ID or inter-cell transmissions.

In another example, the set of transmissions may be at least one of: a set of RSs for positioning, a set of SL-PRSs, a first set of SRSs for positioning, a second set of SRSs for MIMO communication, a first set of uplink transmissions via a PUSCH, or a second set of uplink transmissions via a PUCCH.

In another example, the second TA adjustment procedure may be applied if the UE moves from a first cell in the multiple cells to a second cell in the multiple cells.

In another example, the UE may be is in an RRC inactive state or an RRC idle state within a positioning validity area. In some implementations, the UE may apply a third TA adjustment procedure for the set of transmissions if the UE is in an RRC connected state.

In another example, each of the first TA adjustment procedure and the second TA adjustment procedure may include a maximum amount of magnitude of a timing change in one adjustment, the maximum amount being a fraction of a time difference between a reception time at the UE of a previous DL reference timing and a reception time at the UE of a newly selected DL reference timing.

In another example, to transmit the set of transmissions, the UE may transmit the set of transmissions to at least one network node or at least one sidelink UE.

In another example, to obtain the indication, the UE may obtain the indication explicitly from a network node via signaling, or obtain the indication implicitly based on at least one property associated with the set of transmissions.

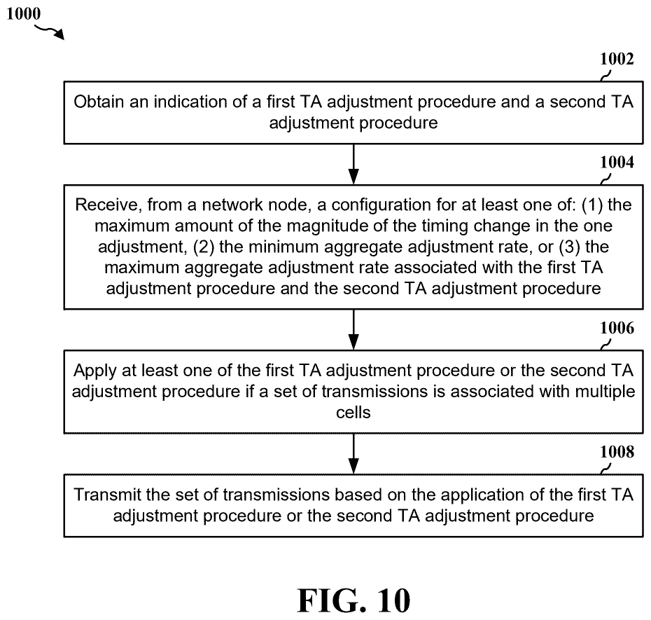

FIG. 10 is a flowchart 1000 of a method of wireless communication. The method may be performed by a UE (e.g., the UE 104, 404, 502, 702, 704, 802; the apparatus 1104). The method may enable the UE to apply and/or to be configured with different gradual/one shot timing adjustment thresholds and parameters for different scenarios and/or conditions, such as when the UE is under inter-cell mobility or intra-cell mobility.

At 1002, the UE may obtain an indication of a first TA adjustment procedure and a second TA adjustment procedure, such as described in connection with FIG. 8. For example, at 812, the UE 802 may obtain an indication of the first TA adjustment procedure and the second TA adjustment procedure from the base station 804. The obtaining of the indication may be performed by, e.g., the timing advance adjustment component 198, the transceiver(s) 1122, the cellular baseband processor(s) 1124, and/or the application processor(s) 1106 of the apparatus 1104 in FIG. 11.

At 1004, the UE may receive, from a network node, a configuration for at least one of. (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure, such as described in connection with FIG. 8. For example, at 818, the UE 802 may receive, from the base station 804, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure. The reception of the configuration may be performed by, e.g., the timing advance adjustment component 198, the transceiver(s) 1122, the cellular baseband processor(s) 1124, and/or the application processor(s) 1106 of the apparatus 1104 in FIG. 11.

At 1006, the UE may apply at least one of the first TA adjustment procedure or the second TA adjustment procedure if a set of transmissions is associated with multiple cells, such as described in connection with FIG. 8. For example, at 814, based on the indication of the first TA adjustment procedure and the second TA adjustment procedure, the UE 802 may apply at least one of the first TA adjustment procedure or the second TA adjustment procedure if a set of transmissions is associated with multiple cells. The application of the first TA adjustment procedure and/or the second TA adjustment procedure may be performed by, e.g., the timing advance adjustment component 198, the transceiver(s) 1122, the cellular baseband processor(s) 1124, and/or the application processor(s) 1106 of the apparatus 1104 in FIG. 11. In some examples, to apply at least one of the first TA adjustment procedure or the second TA adjustment procedure if the set of transmissions is associated with multiple cells, the UE may apply the first TA adjustment procedure if the set of transmissions is associated with a single cell or apply the second TA adjustment procedure if the set of transmissions is associated with multiple cells.

At 1008, the UE may transmit the set of transmissions based on the application of the first TA adjustment procedure or the second TA adjustment procedure, such as described in connection with FIG. 8. For example, at 816, the UE 802 may transmit the set of transmissions based on the application of the first TA adjustment procedure or the second TA adjustment procedure. The transmission of the set of transmissions may be performed by, e.g., the timing advance adjustment component 198, the transceiver(s) 1122, the cellular baseband processor(s) 1124, and/or the application processor(s) 1106 of the apparatus 1104 in FIG. 11.

In one example, the first TA adjustment procedure may be associated with one RS for a DL reference timing determination for the single cell, or the first TA adjustment procedure may be associated with a change to an SSB for the one RS for the DL reference timing determination for the single cell.

In another example, each of the first TA adjustment procedure and the second TA adjustment procedure may be associated with at least one of: a maximum amount of magnitude of a timing change in one adjustment, a minimum aggregate adjustment rate, or a maximum aggregate adjustment rate. In some implementations, the maximum amount of the magnitude of the timing change in the one adjustment, the minimum aggregate adjustment rate, and/or the maximum aggregate adjustment rate may be determined further based on a frequency range and a subcarrier spacing.

In another example, the first TA adjustment procedure and the second TA adjustment procedure may be different in at least one of: a maximum amount of magnitude of a timing change in one adjustment, a minimum aggregate adjustment rate, or a maximum aggregate adjustment rate. In some implementations, at least one of the maximum amount of the magnitude of the timing change in the one adjustment, the minimum aggregate adjustment rate, or the maximum aggregate adjustment rate may be higher for the second TA adjustment compared to the first TA adjustment procedure.

In another example, the first TA adjustment procedure may be associated with intra-cell transmissions, and the second TA adjustment procedure is associated with an area ID or inter-cell transmissions.

In another example, the set of transmissions may be at least one of: a set of RSs for positioning, a set of SL-PRSs, a first set of SRSs for positioning, a second set of SRSs for MIMO communication, a first set of uplink transmissions via a PUSCH, or a second set of uplink transmissions via a PUCCH.

In another example, the second TA adjustment procedure may be applied if the UE moves from a first cell in the multiple cells to a second cell in the multiple cells.

In another example, the UE may be is in an RRC inactive state or an RRC idle state within a positioning validity area. In some implementations, the UE may apply a third TA adjustment procedure for the set of transmissions if the UE is in an RRC connected state.

In another example, each of the first TA adjustment procedure and the second TA adjustment procedure may include a maximum amount of magnitude of a timing change in one adjustment, the maximum amount being a fraction of a time difference between a reception time at the UE of a previous DL reference timing and a reception time at the UE of a newly selected DL reference timing.

In another example, to transmit the set of transmissions, the UE may transmit the set of transmissions to at least one network node or at least one sidelink UE.

In another example, to obtain the indication, the UE may obtain the indication explicitly from a network node via signaling, or obtain the indication implicitly based on at least one property associated with the set of transmissions.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the timing advance adjustment component 198 may be configured to obtain an indication of a first TA adjustment procedure and a second TA adjustment procedure. The timing advance adjustment component 198 may also be configured to apply at least one of the first TA adjustment procedure or the second TA adjustment procedure if a set of transmissions is associated with multiple cells. The timing advance adjustment component 198 may also be configured to transmit the set of transmissions based on the application of the first TA adjustment procedure or the second TA adjustment procedure. The timing advance adjustment component 198 may be within the cellular baseband processor(s) 1124, the application processor(s) 1106, or both the cellular baseband processor(s) 1124 and the application processor(s) 1106. The timing advance adjustment component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for obtaining an indication of a first TA adjustment procedure and a second TA adjustment procedure. The apparatus 1104 may further include means for applying at least one of the first TA adjustment procedure or the second TA adjustment procedure if a set of transmissions is associated with multiple cells. The apparatus 1104 may further include means for transmitting the set of transmissions based on the application of the first TA adjustment procedure or the second TA adjustment procedure.

In one configuration, the apparatus 1104 may further include means for receiving, from a network node, a configuration for at least one of. (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure.

In another configuration, the first TA adjustment procedure may be associated with one RS for a DL reference timing determination for the single cell, or the first TA adjustment procedure may be associated with a change to an SSB for the one RS for the DL reference timing determination for the single cell.

In another configuration, each of the first TA adjustment procedure and the second TA adjustment procedure may be associated with at least one of: a maximum amount of magnitude of a timing change in one adjustment, a minimum aggregate adjustment rate, or a maximum aggregate adjustment rate. In some implementations, the maximum amount of the magnitude of the timing change in the one adjustment, the minimum aggregate adjustment rate, and/or the maximum aggregate adjustment rate may be determined further based on a frequency range and a subcarrier spacing.

In another configuration, the first TA adjustment procedure and the second TA adjustment procedure may be different in at least one of: a maximum amount of magnitude of a timing change in one adjustment, a minimum aggregate adjustment rate, or a maximum aggregate adjustment rate. In some implementations, at least one of the maximum amount of the magnitude of the timing change in the one adjustment, the minimum aggregate adjustment rate, or the maximum aggregate adjustment rate may be higher for the second TA adjustment compared to the first TA adjustment procedure.

In another configuration, the first TA adjustment procedure may be associated with intra-cell transmissions, and the second TA adjustment procedure is associated with an area ID or inter-cell transmissions.

In another configuration, the set of transmissions may be at least one of: a set of RSs for positioning, a set of SL-PRSs, a first set of SRSs for positioning, a second set of SRSs for MIMO communication, a first set of uplink transmissions via a PUSCH, or a second set of uplink transmissions via a PUCCH.

In another configuration, the second TA adjustment procedure may be applied if the UE moves from a first cell in the multiple cells to a second cell in the multiple cells.

In another configuration, the apparatus 1104 may be in an RRC inactive state or an RRC idle state within a positioning validity area. In some implementations, the apparatus 1104 may further include means for applying a third TA adjustment procedure for the set of transmissions if the UE is in an RRC connected state.

In another configuration, each of the first TA adjustment procedure and the second TA adjustment procedure may include a maximum amount of magnitude of a timing change in one adjustment, the maximum amount being a fraction of a time difference between a reception time at the UE of a previous DL reference timing and a reception time at the UE of a newly selected DL reference timing.

In another configuration, the means for transmitting the set of transmissions may include configuring the apparatus 1104 to transmit the set of transmissions to at least one network node or at least one sidelink UE.

In another configuration, the means for obtaining the indication may include configuring apparatus 1104 to obtain the indication explicitly from a network node via signaling, or obtain the indication implicitly based on at least one property associated with the set of transmissions.

The means may be the timing advance adjustment component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

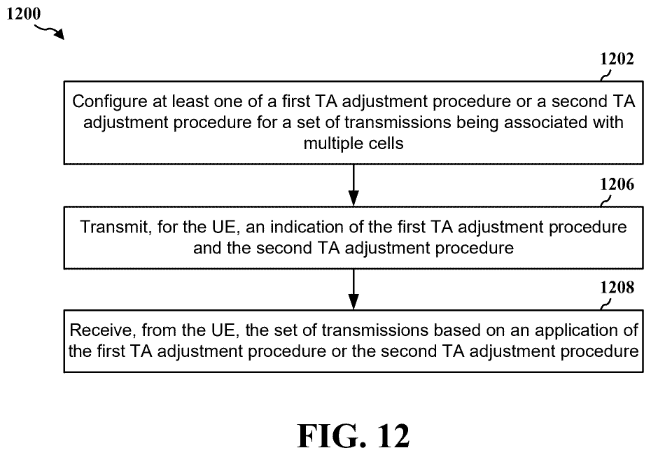

FIG. 12 is a flowchart 1200 of a method of wireless communication. The method may be performed by a base station (e.g., the base station 102, 804; the network node 706; the network entity 1102, 1402). The method may enable the base station to configure a UE with different gradual/one shot timing adjustment thresholds and parameters for different scenarios and/or conditions.

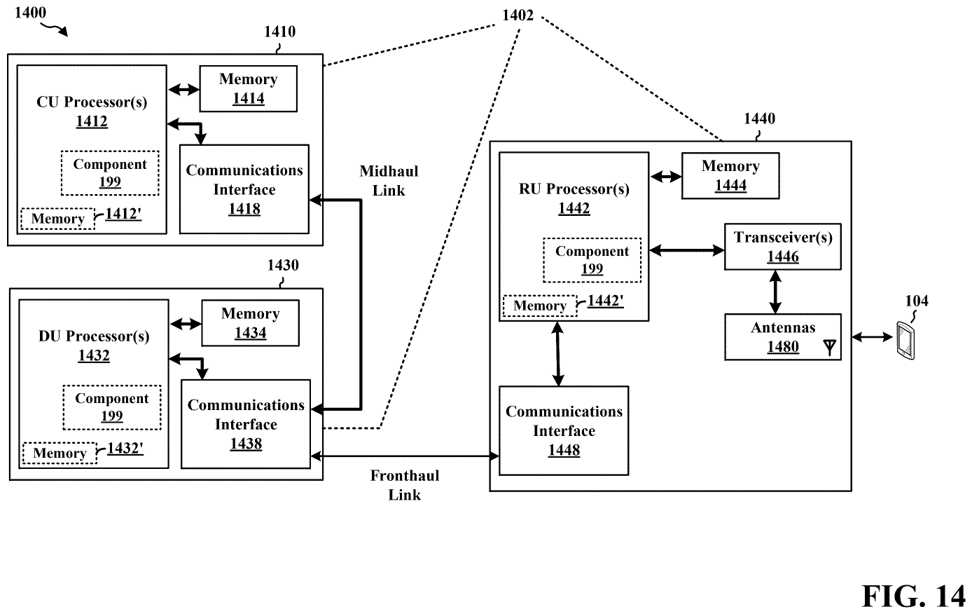

At 1202, the base station may configure at least one of a first TA adjustment procedure or a second TA adjustment procedure for a set of transmissions being associated with multiple cells, such as described in connection with FIG. 8. For example, at 810, the base station 804 (which may be referred to as a network node or a network entity), may configure at least one of a first TA adjustment procedure or a second TA adjustment procedure for a set of transmissions being associated with multiple cells. For example, the base station 804 may configure a first TA adjustment procedure (e.g., a first set of gradual or one shot timing adjustment thresholds and parameters (Tq and Tp)) for a set of transmissions associated with a single cell (e.g., for applying on intra-cell mobility) and/or configure a second TA adjustment procedure (e.g., a second set of gradual or one shot timing adjustment thresholds and parameters (Tq and Tp) that is at least partially different from the first set of gradual or one shot timing adjustment thresholds and parameters) for the set of transmissions associated with multiple cells (e.g., for applying on inter-cell mobility). The configuration of the first TA adjustment procedure and/or the second TA adjustment procedure may be performed by, e.g., the timing advance configuration component 199, the transceiver(s) 1446, the antennas 1480, and/or the RU processor(s) 1442 of the network entity 1402 in FIG. 14. In some implementations, to configure at least one of the first TA adjustment procedure or the second TA adjustment procedure for the set of transmissions being associated with multiple cells, the base station may configure the first TA adjustment procedure for the set of transmissions being associated with a single cell or configure the second TA adjustment procedure for the set of transmissions being associated with multiple cells.

In one example, the base station may transmit, for the UE, a configuration for at least one of. (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure, such as described in connection with FIG. 8. For example, at 818, the base station 804 may transmit, to the UE 802, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure. The transmission of the configuration may be performed by, e.g., the timing advance configuration component 199, the transceiver(s) 1446, the antennas 1480, and/or the RU processor(s) 1442 of the network entity 1402 in FIG. 14.

At 1206, the base station may transmit, for the UE, an indication of the first TA adjustment procedure and the second TA adjustment procedure, such as described in connection with FIG. 8. For example, at 812, the base station 804 may transmit, to or for a UE 802, an indication of the first TA adjustment procedure and the second TA adjustment procedure. The transmission of the indication may be performed by, e.g., the timing advance configuration component 199, the transceiver(s) 1446, the antennas 1480, and/or the RU processor(s) 1442 of the network entity 1402 in FIG. 14.

At 1208, the base station may receive, from the UE, the set of transmissions based on an application of the first TA adjustment procedure or the second TA adjustment procedure, such as described in connection with FIG. 8. For example, at 816, the base station 804 may receive, from the UE 802, the set of transmissions based on an application of the first TA adjustment procedure or the second TA adjustment procedure. The reception of the set of transmissions may be performed by, e.g., the timing advance configuration component 199, the transceiver(s) 1446, the antennas 1480, and/or the RU processor(s) 1442 of the network entity 1402 in FIG. 14.

In one example, the first TA adjustment procedure may be associated with one RS for a DL reference timing determination for the single cell, or the first TA adjustment procedure may be associated with a change to an SSB for the one RS for the DL reference timing determination for the single cell.

In another example, each of the first TA adjustment procedure and the second TA adjustment procedure may be associated with at least one of: a maximum amount of magnitude of a timing change in one adjustment, a minimum aggregate adjustment rate, or a maximum aggregate adjustment rate. In some implementations, the maximum amount of the magnitude of the timing change in the one adjustment, the minimum aggregate adjustment rate, or the maximum aggregate adjustment rate may be determined further based on a frequency range and a subcarrier spacing.

In another example, the first TA adjustment procedure and the second TA adjustment procedure may be different in at least one of: a maximum amount of magnitude of a timing change in one adjustment, a minimum aggregate adjustment rate, or a maximum aggregate adjustment rate. In some implementations, at least one of the maximum amount of the magnitude of the timing change in the one adjustment, the minimum aggregate adjustment rate, or the maximum aggregate adjustment rate may be higher for the second TA adjustment compared to the first TA adjustment procedure.

In another example, the first TA adjustment procedure may be associated with intra-cell transmissions, and the second TA adjustment procedure is associated with an area ID or inter-cell transmissions.

In another example, the set of transmissions may be at least one of: a set of RSs for positioning, a set of SL-PRSs, a first set of SRSs for positioning, a second set of SRSs for MIMO communication, a first set of uplink transmissions via a PUSCH, or a second set of uplink transmissions via a PUCCH.

In another example, the second TA adjustment procedure may be applied if the UE moves from a first cell in the multiple cells to a second cell in the multiple cells.

In another example, the UE is in an RRC inactive state or an RRC idle state within a positioning validity area. In some implementations, the base station may configure, for the UE, to apply a third TA adjustment procedure for the set of transmissions if the UE is in an RRC connected state.

In another example, to transmit the indication, the base station may transmit the indication explicitly to the UE via signaling, or transmit the indication implicitly based on at least one property associated with the set of transmissions.

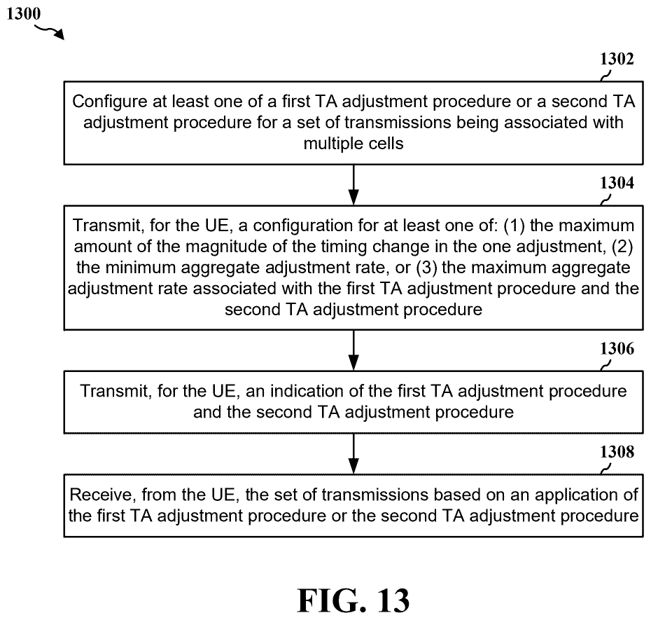

FIG. 13 is a flowchart 1300 of a method of wireless communication. The method may be performed by a base station (e.g., the base station 102, 804; the network node 706; the network entity 1102, 1402). The method may enable the base station to configure a UE with different gradual/one shot timing adjustment thresholds and parameters for different scenarios and/or conditions.

At 1302, the base station may configure at least one of a first timing advance (TA) adjustment procedure or a second TA adjustment procedure for a set of transmissions being associated with multiple cells, such as described in connection with FIG. 8. For example, at 810, the base station 804 at least one of a first timing advance (TA) adjustment procedure or a second TA adjustment procedure for a set of transmissions being associated with multiple cells. For example, the base station 804 may configure a first TA adjustment procedure (e.g., a first set of gradual or one shot timing adjustment thresholds and parameters (Tq and Tp)) for a set of transmissions associated with a single cell (e.g., for applying on intra-cell mobility) and/or configure a second TA adjustment procedure (e.g., a second set of gradual or one shot timing adjustment thresholds and parameters (Tq and Tp) that is at least partially different from the first set of gradual or one shot timing adjustment thresholds and parameters) for the set of transmissions associated with multiple cells (e.g., for applying on inter-cell mobility). The configuration of the first TA adjustment procedure and/or the second TA adjustment procedure may be performed by, e.g., the timing advance configuration component 199, the transceiver(s) 1446, the antennas 1480, and/or the RU processor(s) 1442 of the network entity 1402 in FIG. 14. In some implementations, to configure at least one of the first TA adjustment procedure or the second TA adjustment procedure for the set of transmissions being associated with multiple cells, the base station may configure the first TA adjustment procedure for the set of transmissions being associated with a single cell or configure the second TA adjustment procedure for the set of transmissions being associated with multiple cells.

At 1304, the base station may transmit, for the UE, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure, such as described in connection with FIG. 8. For example, at 818, the base station 804 may transmit, to the UE 802, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure. The transmission of the configuration may be performed by, e.g., the timing advance configuration component 199, the transceiver(s) 1446, the antennas 1480, and/or the RU processor(s) 1442 of the network entity 1402 in FIG. 14.

At 1306, the base station may transmit, for the UE, an indication of the first TA adjustment procedure and the second TA adjustment procedure, such as described in connection with FIG. 8. For example, at 812, the base station 804 may transmit, to or for a UE 802, an indication of the first TA adjustment procedure and the second TA adjustment procedure. The transmission of the indication may be performed by, e.g., the timing advance configuration component 199, the transceiver(s) 1446, the antennas 1480, and/or the RU processor(s) 1442 of the network entity 1402 in FIG. 14.

At 1308, the base station may receive, from the UE, the set of transmissions based on an application of the first TA adjustment procedure or the second TA adjustment procedure, such as described in connection with FIG. 8. For example, at 816, the base station 804 may receive, from the UE 802, the set of transmissions based on an application of the first TA adjustment procedure or the second TA adjustment procedure. The reception of the set of transmissions may be performed by, e.g., the timing advance configuration component 199, the transceiver(s) 1446, the antennas 1480, and/or the RU processor(s) 1442 of the network entity 1402 in FIG. 14.

In one example, the first TA adjustment procedure may be associated with one RS for a DL reference timing determination for the single cell, or the first TA adjustment procedure may be associated with a change to an SSB for the one RS for the DL reference timing determination for the single cell.

In another example, each of the first TA adjustment procedure and the second TA adjustment procedure may be associated with at least one of: a maximum amount of magnitude of a timing change in one adjustment, a minimum aggregate adjustment rate, or a maximum aggregate adjustment rate. In some implementations, the maximum amount of the magnitude of the timing change in the one adjustment, the minimum aggregate adjustment rate, or the maximum aggregate adjustment rate may be determined further based on a frequency range and a subcarrier spacing.

In another example, the first TA adjustment procedure and the second TA adjustment procedure may be different in at least one of: a maximum amount of magnitude of a timing change in one adjustment, a minimum aggregate adjustment rate, or a maximum aggregate adjustment rate. In some implementations, at least one of the maximum amount of the magnitude of the timing change in the one adjustment, the minimum aggregate adjustment rate, or the maximum aggregate adjustment rate may be higher for the second TA adjustment compared to the first TA adjustment procedure.

In another example, the first TA adjustment procedure may be associated with intra-cell transmissions, and the second TA adjustment procedure is associated with an area ID or inter-cell transmissions.

In another example, the set of transmissions may be at least one of: a set of RSs for positioning, a set of SL-PRSs, a first set of SRSs for positioning, a second set of SRSs for MIMO communication, a first set of uplink transmissions via a PUSCH, or a second set of uplink transmissions via a PUCCH.

In another example, the second TA adjustment procedure may be applied if the UE moves from a first cell in the multiple cells to a second cell in the multiple cells.

In another example, the UE is in an RRC inactive state or an RRC idle state within a positioning validity area. In some implementations, the base station may configure, for the UE, to apply a third TA adjustment procedure for the set of transmissions if the UE is in an RRC connected state.

In another example, to transmit the indication, the base station may transmit the indication explicitly to the UE via signaling, or transmit the indication implicitly based on at least one property associated with the set of transmissions.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the timing advance configuration component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the timing advance configuration component 199 may be configured to configure at least one of a first TA adjustment procedure or a second TA adjustment procedure for a set of transmissions being associated with multiple cells. The timing advance configuration component 199 may also be configured to transmit, for a UE, an indication of the first TA adjustment procedure and the second TA adjustment procedure. The timing advance configuration component 199 may also be configured to receive, from the UE, the set of transmissions based on an application of the first TA adjustment procedure or the second TA adjustment procedure. The timing advance configuration component 199 may be within one or more processors of one or more of the CU 1410, DU 1430, and the RU 1440. The timing advance configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for configuring at least one of a first TA adjustment procedure or a second TA adjustment procedure for a set of transmissions being associated with multiple cells. The network entity 1402 may further include means for transmitting, for a UE, an indication of the first TA adjustment procedure and the second TA adjustment procedure. The network entity 1402 may further include means for receiving, from the UE, the set of transmissions based on an application of the first TA adjustment procedure or the second TA adjustment procedure.

In one configuration, the network entity 1402 may further include means for transmitting, for the UE, a configuration for at least one of. (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure.

In another configuration, the first TA adjustment procedure may be associated with one RS for a DL reference timing determination for the single cell, or the first TA adjustment procedure may be associated with a change to an SSB for the one RS for the DL reference timing determination for the single cell.

In another configuration, each of the first TA adjustment procedure and the second TA adjustment procedure may be associated with at least one of: a maximum amount of magnitude of a timing change in one adjustment, a minimum aggregate adjustment rate, or a maximum aggregate adjustment rate. In some implementations, the maximum amount of the magnitude of the timing change in the one adjustment, the minimum aggregate adjustment rate, or the maximum aggregate adjustment rate may be determined further based on a frequency range and a subcarrier spacing.

In another configuration, the first TA adjustment procedure and the second TA adjustment procedure may be different in at least one of: a maximum amount of magnitude of a timing change in one adjustment, a minimum aggregate adjustment rate, or a maximum aggregate adjustment rate. In some implementations, at least one of the maximum amount of the magnitude of the timing change in the one adjustment, the minimum aggregate adjustment rate, or the maximum aggregate adjustment rate may be higher for the second TA adjustment compared to the first TA adjustment procedure.

In another configuration, the first TA adjustment procedure may be associated with intra-cell transmissions, and the second TA adjustment procedure is associated with an area ID or inter-cell transmissions.

In another configuration, the set of transmissions may be at least one of: a set of RSs for positioning, a set of SL-PRSs, a first set of SRSs for positioning, a second set of SRSs for MIMO communication, a first set of uplink transmissions via a PUSCH, or a second set of uplink transmissions via a PUCCH.

In another configuration, the second TA adjustment procedure may be applied if the UE moves from a first cell in the multiple cells to a second cell in the multiple cells.

In another configuration, the UE is in an RRC inactive state or an RRC idle state within a positioning validity area. In some implementations, the network entity 1402 may further include means for configuring, for the UE, to apply a third TA adjustment procedure for the set of transmissions if the UE is in an RRC connected state.

In another configuration, to transmit the indication, the base station may transmit the indication explicitly to the UE via signaling, or transmit the indication implicitly based on at least one property associated with the set of transmissions.

The means may be the timing advance configuration component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment, comprising: obtaining an indication of a first timing advance (TA) adjustment procedure and a second TA adjustment procedure; applying at least one of the first TA adjustment procedure or the second TA adjustment procedure if a set of transmissions is associated with multiple cell; and transmitting the set of transmissions based on the application of the first TA adjustment procedure or the second TA adjustment procedure.

Aspect 2 is the method of aspect 1, wherein the first TA adjustment procedure is associated with one reference signal (RS) for a downlink (DL) reference timing determination for the single cell, or wherein the first TA adjustment procedure is associated with a change to a synchronization signal block (SSB) for the one RS for the DL reference timing determination for the single cell.

Aspect 3 is the method of aspect 1 or aspect 2, wherein each of the first TA adjustment procedure and the second TA adjustment procedure is associated with at least one of: a maximum amount of magnitude of a timing change in one adjustment, a minimum aggregate adjustment rate, or a maximum aggregate adjustment rate.

Aspect 4 is the method of any of aspects 1 to 3, wherein the maximum amount of the magnitude of the timing change in the one adjustment, the minimum aggregate adjustment rate, or the maximum aggregate adjustment rate is determined further based on a frequency range and a subcarrier spacing.

Aspect 5 is the method of any of aspects 1 to 4, further comprising: receiving, from a network node, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure.

Aspect 6 is the method of any of aspects 1 to 5, wherein the first TA adjustment procedure and the second TA adjustment procedure are different in at least one of: a maximum amount of magnitude of a timing change in one adjustment, a minimum aggregate adjustment rate, or a maximum aggregate adjustment rate.

Aspect 7 is the method of any of aspects 1 to 6, wherein at least one of the maximum amount of the magnitude of the timing change in the one adjustment, the minimum aggregate adjustment rate, or the maximum aggregate adjustment rate is higher for the second TA adjustment compared to the first TA adjustment procedure.

Aspect 8 is the method of any of aspects 1 to 7, wherein the first TA adjustment procedure is associated with intra-cell transmissions, and wherein the second TA adjustment procedure is associated with an area identifier (ID) or inter-cell transmissions.

Aspect 9 is the method of any of aspects 1 to 8, wherein the set of transmissions is at least one of: a set of reference signals (RSs) for positioning, a set of sidelink (SL) positioning reference signals (PRSs) (SL-PRSs), a first set of sounding reference signals (SRSs) for positioning, a second set of SRSs for multiple-input multiple-output (MIMO) communication, a first set of uplink transmissions via a physical uplink shared channel (PUSCH), or a second set of uplink transmissions via a physical uplink control channel (PUCCH).

Aspect 10 is the method of any of aspects 1 to 9, wherein the second TA adjustment procedure is applied if the UE moves from a first cell in the multiple cells to a second cell in the multiple cells.

Aspect 11 is the method of any of aspects 1 to 10, wherein the UE is in a radio resource control (RRC) inactive state or an RRC idle state within a positioning validity area.

Aspect 12 is the method of any of aspects 1 to 11, further comprising: applying a third TA adjustment procedure for the set of transmissions if the UE is in an RRC connected state.

Aspect 13 is the method of any of aspects 1 to 12, wherein each of the first TA adjustment procedure and the second TA adjustment procedure includes a maximum amount of magnitude of a timing change in one adjustment, the maximum amount being a fraction of a time difference between a first reception time at the UE of a previous downlink (DL) reference timing and a second reception time at the UE of a newly selected DL reference timing.

Aspect 14 is the method of any of aspects 1 to 13, wherein transmitting the set of transmissions comprises transmitting the set of transmissions to at least one network node or at least one sidelink UE.

Aspect 15 is the method of any of aspects 1 to 14, wherein obtaining the indication comprises at least one of: obtaining the indication explicitly from a network node via signaling, or obtaining the indication implicitly based on at least one property associated with the set of transmissions.

Aspect 16 is the method of any of aspects 1 to 15, wherein applying at least one of the first TA adjustment procedure or the second TA adjustment procedure if the set of transmissions is associated with multiple cells comprises: applying the first TA adjustment procedure if the set of transmissions is associated with a single cell or applying the second TA adjustment procedure if the set of transmissions is associated with multiple cells.

Aspect 17 is an apparatus for wireless communication at a user equipment, including: at least one memory; and at least one processor coupled to the at least one memory and, based at least in part on information stored in the at least one memory, the at least one processor, individually or in any combination, is configured to implement any of aspects 1 to 16.

Aspect 18 is the apparatus of aspect 16, further including at least one of a transceiver or an antenna coupled to the at least one processor.

Aspect 19 is an apparatus for wireless communication including means for implementing any of aspects 1 to 16.

Aspect 20 is a computer-readable medium (e.g., a non-transitory computer-readable medium) storing computer executable code, where the code when executed by a processor causes the processor to implement any of aspects 1 to 16.

Aspect 21 is a method of wireless communication at a network node, comprising: configuring at least one of a first timing advance (TA) adjustment procedure or a second TA adjustment procedure for a set of transmissions being associated with multiple cells; transmitting, for a user equipment (UE), an indication of the first TA adjustment procedure and the second TA adjustment procedure; and receiving, from the UE, the set of transmissions based on an application of the first TA adjustment procedure or the second TA adjustment procedure.

Aspect 22 is the method of aspect 21, wherein the first TA adjustment procedure is associated with one reference signal (RS) for a downlink (DL) reference timing determination for the single cell, or wherein the first TA adjustment procedure is associated with a change to a synchronization signal block (SSB) for the one RS for the DL reference timing determination for the single cell.

Aspect 23 is the method of aspect 21 or aspect 22, wherein each of the first TA adjustment procedure and the second TA adjustment procedure is associated with at least one of: a maximum amount of magnitude of a timing change in one adjustment, a minimum aggregate adjustment rate, or a maximum aggregate adjustment rate.

Aspect 24 is the method of any of aspects 21 to 23, wherein the maximum amount of the magnitude of the timing change in the one adjustment, the minimum aggregate adjustment rate, or the maximum aggregate adjustment rate is determined further based on a frequency range and a subcarrier spacing.

Aspect 25 is the method of any of aspects 21 to 24, further comprising: transmitting, for the UE, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure.

Aspect 26 is the method of any of aspects 21 to 25, wherein the first TA adjustment procedure and the second TA adjustment procedure are different in at least one of: a maximum amount of magnitude of a timing change in one adjustment, a minimum aggregate adjustment rate, or a maximum aggregate adjustment rate.

Aspect 27 is the method of any of aspects 21 to 26, wherein at least one of the maximum amount of the magnitude of the timing change in the one adjustment, the minimum aggregate adjustment rate, or the maximum aggregate adjustment rate is higher for the second TA adjustment compared to the first TA adjustment procedure.

Aspect 28 is the method of any of aspects 21 to 27, wherein the first TA adjustment procedure is associated with intra-cell transmissions, and wherein the second TA adjustment procedure is associated with an area identifier (ID) or inter-cell transmissions.

Aspect 29 is the method of any of aspects 21 to 28, wherein the set of transmissions is at least one of: a set of reference signals (RSs) for positioning, a set of sidelink (SL) positioning reference signals (PRSs) (SL-PRSs), a first set of sounding reference signals (SRSs) for positioning, a second set of SRSs for multiple-input multiple-output (MIMO) communication, a first set of uplink transmissions via a physical uplink shared channel (PUSCH), or a second set of uplink transmissions via a physical uplink control channel (PUCCH).

Aspect 30 is the method of any of aspects 21 to 29, wherein the second TA adjustment procedure is applied if the UE moves from a first cell in the multiple cells to a second cell in the multiple cells.

Aspect 31 is the method of any of aspects 21 to 30, wherein the UE is in a radio resource control (RRC) inactive state or an RRC idle state within a positioning validity area.

Aspect 32 is the method of any of aspects 21 to 31, further comprising: configuring the UE to apply a third TA adjustment procedure for the set of transmissions if the UE is in an RRC connected state.

Aspect 33 is the method of any of aspects 21 to 32, wherein transmitting the indication comprises at least one of: transmitting the indication explicitly to the UE via signaling, or transmitting the indication implicitly based on at least one property associated with the set of transmissions.

Aspect 34 is the method of any of aspects 21 to 33, wherein configuring at least one of the first TA adjustment procedure or the second TA adjustment procedure for the set of transmissions being associated with multiple cells comprises: configuring the first TA adjustment procedure for the set of transmissions being associated with a single cell or configuring the second TA adjustment procedure for the set of transmissions being associated with multiple cells.

Aspect 35 is an apparatus for wireless communication at a network node, including: at least one memory; and at least one processor coupled to the at least one memory and, based at least in part on information stored in the at least one memory, the at least one processor, individually or in any combination, is configured to implement any of aspects 21 to 34.

Aspect 36 is the apparatus of aspect 33, further including at least one of a transceiver or an antenna coupled to the at least one processor.

Aspect 37 is an apparatus for wireless communication including means for implementing any of aspects 21 to 34.

Aspect 38 is a computer-readable medium (e.g., a non-transitory computer-readable medium) storing computer executable code, where the code when executed by a processor causes the processor to implement any of aspects 21 to 34.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
obtain an indication of a first timing advance (TA) adjustment procedure and a second TA adjustment procedure;
apply at least one of the first TA adjustment procedure or the second TA adjustment procedure if a set of transmissions is associated with multiple cells; and
transmit the set of transmissions based on the application of the first TA adjustment procedure or the second TA adjustment procedure.

2. The apparatus of claim 1, wherein to apply at least one of the first TA adjustment procedure or the second TA adjustment procedure if the set of transmissions is associated with the multiple cells, the at least one processor, individually or in any combination, is configured to:
apply the first TA adjustment procedure if the set of transmissions is associated with a single cell or apply the second TA adjustment procedure if the set of transmissions is associated with the multiple cells.

3. The apparatus of claim 1, wherein each of the first TA adjustment procedure and the second TA adjustment procedure is associated with at least one of:
a maximum amount of magnitude of a timing change in one adjustment,
a minimum aggregate adjustment rate, or
a maximum aggregate adjustment rate.

4. The apparatus of claim 3, wherein the maximum amount of the magnitude of the timing change in the one adjustment, the minimum aggregate adjustment rate, or the maximum aggregate adjustment rate is determined further based on a frequency range and a subcarrier spacing.

5. The apparatus of claim 3, wherein the at least one processor, individually or in any combination, is further configured to:
receive, from a network node, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure.

6. The apparatus of claim 1, wherein the first TA adjustment procedure and the second TA adjustment procedure are different in at least one of:
a maximum amount of magnitude of a timing change in one adjustment,
a minimum aggregate adjustment rate, or
a maximum aggregate adjustment rate.

7. The apparatus of claim 6, wherein at least one of the maximum amount of the magnitude of the timing change in the one adjustment, the minimum aggregate adjustment rate, or the maximum aggregate adjustment rate is higher for the second TA adjustment compared to the first TA adjustment procedure.

8. The apparatus of claim 1, wherein the first TA adjustment procedure is associated with intra-cell transmissions, and wherein the second TA adjustment procedure is associated with an area identifier (ID) or inter-cell transmissions.

9. The apparatus of claim 1, wherein the set of transmissions is at least one of:
a set of reference signals (RSs) for positioning,
a set of sidelink (SL) positioning reference signals (PRSs) (SL-PRSs), a first set of sounding reference signals (SRSs) for positioning,
a second set of SRSs for multiple-input multiple-output (MIMO) communication,
a first set of uplink transmissions via a physical uplink shared channel (PUSCH), or
a second set of uplink transmissions via a physical uplink control channel (PUCCH).

10. The apparatus of claim 1, wherein the second TA adjustment procedure is applied if the UE moves from a first cell in the multiple cells to a second cell in the multiple cells.

11. The apparatus of claim 1, wherein the UE is in a radio resource control (RRC) inactive state or an RRC idle state within a positioning validity area.

12. The apparatus of claim 11, wherein the at least one processor, individually or in any combination, is further configured to:
apply a third TA adjustment procedure for the set of transmissions if the UE is in an RRC connected state.

13. The apparatus of claim 1, wherein each of the first TA adjustment procedure and the second TA adjustment procedure includes a maximum amount of magnitude of a timing change in one adjustment, the maximum amount being a fraction of a time difference between a first reception time at the UE of a previous downlink (DL) reference timing and a second reception time at the UE of a newly selected DL reference timing.

14. The apparatus of claim 1, wherein the first TA adjustment procedure is associated with one reference signal (RS) for a downlink (DL) reference timing determination for a single cell, or wherein the first TA adjustment procedure is associated with a change to a synchronization signal block (SSB) for the one RS for the DL reference timing determination for the single cell.

15. The apparatus of claim 1, wherein to obtain the indication, the at least one processor, individually or in any combination, is configured to:
obtain the indication explicitly from a network node via signaling, or
obtain the indication implicitly based on at least one property associated with the set of transmissions.

16. A method of wireless communication at a user equipment (UE), comprising:
obtaining an indication of a first timing advance (TA) adjustment procedure and a second TA adjustment procedure;
applying at least one of the first TA adjustment procedure or the second TA adjustment procedure if a set of transmissions is associated with multiple cells; and
transmitting the set of transmissions based on the application of the first TA adjustment procedure or the second TA adjustment procedure.

17. An apparatus for wireless communication at a network node, comprising:
at least one memory; and
at least one processor coupled to the at least one memory and, based at least in part on information stored in the at least one memory, the at least one processor, individually or in any combination, is configured to:
configure at least one of a first timing advance (TA) adjustment procedure or a second TA adjustment procedure for a set of transmissions being associated with multiple cells;
transmit, for a user equipment (UE), an indication of the first TA adjustment procedure and the second TA adjustment procedure; and
receive, from the UE, the set of transmissions based on an application of the first TA adjustment procedure or the second TA adjustment procedure.

18. The apparatus of claim 17, wherein to configure at least one of the first TA adjustment procedure or the second TA adjustment procedure for the set of transmissions being associated with the multiple cells, the at least one processor, individually or in any combination, is configured to:
configure the first TA adjustment procedure for the set of transmissions being associated with a single cell or configure the second TA adjustment procedure for the set of transmissions being associated with the multiple cells.

19. The apparatus of claim 17, wherein each of the first TA adjustment procedure and the second TA adjustment procedure is associated with at least one of
a maximum amount of magnitude of a timing change in one adjustment,
a minimum aggregate adjustment rate, or
a maximum aggregate adjustment rate.

20. The apparatus of claim 19, wherein the at least one processor, individually or in any combination, is further configured to:
transmit, for the UE, a configuration for at least one of: (1) the maximum amount of the magnitude of the timing change in the one adjustment, (2) the minimum aggregate adjustment rate, or (3) the maximum aggregate adjustment rate associated with the first TA adjustment procedure and the second TA adjustment procedure.
